(19) United States
(12) Patent Application Publication
(10) Pub. No.: US 2022/0155850 A1
(43) Pub. Date: May 19, 2022

(54) METHOD AND SYSTEM FOR AN IMMERSIVE AND RESPONSIVE ENHANCED REALITY

(71) Applicant: InVeris Training Solutions, Inc., Suwanee, VA (US)

(72) Inventors: Marwan Kodeih, Dallas, TX (US); Connor Nesbitt, Richardson, TX (US)

(73) Assignee: InVeris Training Solutions, Inc., Suwanee, GA (US)

(21) Appl. No.: 17/525,613

(22) Filed: Nov. 12, 2021

Related U.S. Application Data
(60) Provisional application No. 63/113,679, filed on Nov. 13, 2020.

(51) Int. Cl. G06F 3/01; G06F 3/16

(52) U.S. Cl. CPC G06F 3/011; G06F 3/0482; G06F 3/167

(57) ABSTRACT

Systems and methods for providing an immersive and response reality. The method includes outputting, to a first interface in communication with a first user, an option for selecting an enhanced environment, receiving, from the first interface, a selection of the enhanced environment, and generating the enhanced environment based on the selection. The method includes generating, in the enhanced environment, a model avatar and a user avatar representative of a second user, and an instrument avatar representative of an instrument selected by and associated with the second user. The method includes outputting, to the first interface and a second interface in communication with the second user, the enhanced environment and a position of the second user, instrument and model avatars in the enhanced environment, performing, based on a first action, a sequential animation from the position of the model avatar to a second position in the enhanced environment.

### CROSS-REFERENCE TO RELATED APPLICATION

This application claims priority to and the benefit of U.S. Provisional Application Patent Ser. No. 63/113,679, filed Nov. 13, 2020, titled “Method and System for an Immersive and Responsive Enhanced Reality”. The entire disclosure of the above-referenced application is hereby incorporated by reference.

### BACKGROUND

Immersive and responsive training of law enforcement officers aids in training officers to have measured and proportional response to stressful situations—for the officer and third parties. Currently, law enforcement relies on simulations between a seasoned officer, or other individual, and a training officer. Aiding in the simulations, audio, visual, and/or audiovisual communications often disorient and distract the training officer. These simulations, though effective, fail to immerse the training officer in an environment they have no familiarity with and can be susceptible to bias.

### SUMMARY

An aspect of the disclosed embodiments include a method providing an immersive and response reality, i.e., an enhanced environment. The method comprises selecting an enhanced environment and presenting, to a first user with an interface, the enhanced environment based on the selection. The method comprises presenting, in the enhanced environment, a model avatar and a user avatar representative of the first user. The method comprises receiving first user position data representative of a location of the first user and positioning, in the enhanced environment, the user avatar based on user position data. The method comprises presenting an instrument avatar representative of an instrument selected by and associated with the first user. The method comprises receiving instrument position data representative of a location of the instrument and positioning, in the enhanced environment, the instrument avatar based on the instrument position data. The method comprises initiating an action of the model avatar based on the enhanced environment and presenting the first action in the enhanced environment.

Another aspect of the disclosed embodiments includes a system that includes a processing device and a memory communicatively coupled to the processing device and capable of storing instructions. The processing device executes the instructions to perform any of the methods, operations, or steps described herein.

Another aspect of the disclosed embodiments includes a tangible, non-transitory computer-readable medium storing instructions that, when executed, cause a processing device to perform any of the methods, operations, or steps described herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a block diagram of an embodiment of a computer-implemented system, for providing an immersive and response reality, according to the principles of the present disclosure.

FIG. 2A is a flow diagram generally illustrating an example method, for providing an immersive and response reality, according to the principles of the present disclosure.

FIG. 2B is a flow diagram generally illustrating another example method, for providing an immersive and response reality, according to the principles of the present disclosure.

FIG. 3 generally illustrates a user interface presenting options for selecting an enhanced environment according to the principles of the present disclosure.

FIG. 4 generally illustrates a user interface presenting options for selecting an action of a model avatar in an enhanced environment according to the principles of the present disclosure.

FIG. 5 generally illustrates a user interface presenting a user avatar, an instrument avatar and a model avatar in an enhanced environment according to the principles of the present disclosure.

FIGS. 6-8 generally illustrate embodiments of instruments according to the principles of the present disclosure.

FIG. 9 generally illustrates a user interface presenting options for selecting an action of a model avatar in an enhanced environment according to the principles of the present disclosure.

FIGS. 10-12 generally illustrates a user interface presenting options for selecting a model avatar in an enhanced environment according to the principles of the present disclosure.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The term “enhanced reality,” “extended reality” or “enhanced environment” may include a user experience comprising one or more of an interaction with a computer, augmented reality, virtual reality, mixed reality, immersive reality, or a combination of the foregoing (e.g., immersive augmented reality, mixed augmented reality, virtual and augmented immersive reality, and the like).

The term “augmented reality” may refer, without limitation, to an interactive user experience that provides an enhanced environment that combines elements of a real-world environment with computer-generated components perceivable by the user.

The term “virtual reality” may refer, without limitation, to a simulated interactive user experience that provides an enhanced environment perceivable by the user and wherein such enhanced environment may be similar to or different from a real-world environment.

The term “mixed reality” may refer to an interactive user experience that combines aspects of augmented reality with aspects of virtual reality to provide a mixed reality environment perceivable by the user.

The term “immersive reality” may refer to a simulated interactive user experienced using virtual and/or augmented reality images, sounds, and other stimuli to immerse the user, to a specific extent possible (e.g., partial immersion or total immersion), in the simulated interactive experience. For example, in some embodiments, to the specific extent possible, the user experiences one or more aspects of the immersive reality as naturally as the user typically experiences corresponding aspects of the real-world. Additionally, or alternatively, an immersive reality experience may include actors, a narrative component, a theme (e.g., an entertainment theme or other suitable theme), and/or other suitable features of components.

The term “body halo” may refer to a hardware component or components, wherein such component or components may include one or more platforms, one or more body supports or cages, one or more chairs or seats, one or more back supports, one or more leg or foot engaging mechanisms, one or more arm or hand engaging mechanisms, one or more neck or head engaging mechanisms, other suitable hardware components, or a combination thereof.

As used herein, the term “enhanced environment” may refer to an enhanced environment in its entirety, at least one aspect of the enhanced environment, more than one aspect of the enhanced environment, or any suitable number of aspects of the enhanced environment.

### DETAILED DESCRIPTION

The following discussion is directed to various embodiments of the present disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In some embodiments, the systems and methods described herein may provide an immersive and response reality, such as an enhanced reality or environment, or an augmented, virtual, mixed or immersive reality. The systems and methods provided herein may provide an immersive and response reality for an individual, such as a trainee in law enforcement or a civilian. It should be noted that any suitable trainee (e.g., clerk, agent, fire fighter, Emergency Medical Technician (EMT), first responder, pilot, bus driver, ship captain, teacher, guide, military personnel, security guard, etc.), may use the disclosed techniques. In some embodiments, the immersive and responsive reality may provide an enhanced environment for a trainee of law enforcement and simulate various people the trainee of law enforcement may encounter in various real-world situations. The enhanced environment may simulate a law enforcement officer's interaction with a suspect, a mentally unstable person, a criminal person and/or other person the officer may encounter. In some embodiments, the enhanced environment may include avatars of a trainee and multiple model avatars of one or more suspects (e.g., 1, 2, 3, 4, 5) in a simulation of a situation (e.g., a riot). In some embodiments, the enhanced environment may include one or more trainees and an avatar associated with each trainee and one or more model avatars in a simulation of a situation (e.g., a riot, or other situation involving more than one officer and more than one suspect). The enhanced environment may simulate a person breaking into a home or an active shooter. The enhanced environment may simulate past realities, parts of past realities, or be fictitious.

The system and methods described herein are particularly advantageous for training civilians and law enforcement to use weapons, such as a gun, Taser, baton, blunt or sharp object, etc., in a measured and proportional manner and while experiencing the physical and psychological effects of “fight-or-flight.” In some embodiments, instrument avatars for the various weapons may be generated and provided in the enhanced environment. In some embodiments, one or more instrument avatars may be provided in the enhanced environment. For example, in some embodiments, the trainee may use an instrument avatar representing a Taser to attack a suspect, but if the suspect is on a drug like PCP and does not respond to the Taser, the trainee may use another instrument avatar representing another weapon, in real-time (e.g., less than 5 seconds) or near real-time (e.g., between 5 seconds and 20 seconds), such as a handgun to complete the training session. In some embodiments, the instruments may be attached to a trainee (e.g., located in a holster or vest) and an instrument avatar may reflect the location of the instrument in the enhanced environment.

The systems and method described herein provide advantages for immersive and responsive training by removing any element of familiarity (e.g., other officer/familiar person playing the role of the, per se, “suspect,” or familiar training facility) and immerses the individual in an unfamiliar environment, forcing the individual to respond to unpredictable actions of a “suspect.” Some current training environments have become predictable for trainees, which places the officer and the “suspect” at risk—on either side—of a reactive, unmeasured and disproportional response. By playing loud noise, blaring music, screaming, etc., these training methods may invoke a partial “fight-or-flight” by increasing an individual's heart rate and blood pressure but they may fail to, per se, “trick” the brain into believing the individual is in fact at risk of imminent harm. The systems and methods of the present disclosure, and specifically, the enhanced environment provided by the same is more likely to “trick” the brain into fearing imminent harm to the individual. Thereby, the individual is more likely to experience the true physical and psychological responses due to “fight-or-flight” that an otherwise controlled or predictable simulation fails to achieve. The systems and methods described herein, by being unfamiliar and unpredictable, are more likely to invoke the “fight-or-flight” response and provide the individual the opportunity to de-escalate situations, or to use reasonable and measured force, in the face of “fight-or flight.”

Some embodiments of the systems and method of the disclosure may present a selection for an enhanced environment. The systems and methods may present, to a first user with an interface, the enhanced environment based on the selection. The first interface may be one of an augmented reality device, a virtual reality device, a mixed reality device, and an immersive reality device configured to present the enhanced environment. The systems and methods may present, in the enhanced environment, a model avatar and a user avatar representative of the first user. The systems and methods may receive first user position data representative of a location of the first user and position, in the enhanced environment, the user avatar based on user position data. The systems and methods may present, in the enhanced environment, an instrument avatar representative of an instrument selected by and associated with the first user. The systems and methods may receive instrument position data representative of a location of the instrument and position, in the enhanced environment, the position of the instrument avatar based on the instrument position data. The systems and methods may initiate an action performed by the model avatar and present the action in the enhanced environment.

In some embodiments, the systems and methods may receive dynamic first user and instrument position data representative of a dynamic movement of at least one of the first user and instrument. The systems and methods may present, in the enhanced environment, movement of the user and instrument avatars based on the dynamic movement of the first user and the instrument. The systems and methods may selectively modify, based on at least one of the position and dynamic movement of at least one of the first user and the instrument, a second action of the avatar. The systems and methods may receive an audible command of the first user.

In some embodiments, the systems and methods may selectively modify, based at least in part on the audible command, a second action of the model avatar. The systems and methods may selectively identify a bias of the first user. The systems and methods may selectively identify a bias of the second user based at least in part on one of the enhanced environment, dynamic movement, and the audible command. The systems and methods may selectively modify, based on the identified bias, a third action of the model avatar. The systems and methods may receive a first user measurement where the first user measurement is at least one of a vital sign of the user, a respiration rate of the user, a heart rate of the user, a temperature of the user, an eye dilation, a metabolic marker, a biomarker, and a blood pressure of the user. The systems and methods may identify, based on the first user measurement, a bias of the second user.

In some embodiments, the systems and methods comprise a processing device and a memory. The memory may be communicatively coupled to the processing device and include computer readable instructions (referred hereafter interchangeable with “instructions”) that are executed by the processing device (referred hereafter interchangeably with “processors” or “processors”) and cause the processing device to perform an action.

In some embodiment of the systems and methods, the memory may include instructions causing the processor to output, to a first interface in communication with a first user, an option for selecting an enhanced environment. The memory may include instructions causing the processor to receive, from the first interface, a selection of the enhanced environment. The memory may include instructions causing the processor to generate an enhanced environment based on the selection. The memory may include instructions causing the processor to generate, in the enhanced environment, a model avatar and a user avatar representative of a second user. The memory may include instructions causing the processor to generate, in the enhanced environment, a plurality of model avatars and user avatars representative of users. The memory may include instructions causing the processor to receive, from position sensors, second user position data representative of a location of the second user. The memory may include instructions causing the processor to generate, from the second user position data, a position of the second user avatar in the enhanced environment. The memory may include instructions causing the processor to generate, in the enhanced environment, an instrument avatar representative of an instrument selected by and associated with the second user. The memory may include instructions causing the processor to receive, from position sensors, instrument position data representative of a location of the instrument. The memory may include instructions causing the processor to generate, from the instrument data, a position of the instrument avatar in the enhanced environment. The memory may include instructions causing the processor to output, to a second interface in communication with the second user, the enhanced environment and positions of the users, instruments and model avatar in the enhanced environment. The first and second interfaces may be any one of an augmented reality device, a virtual reality device, a mixed reality device, and an immersive reality device configured to present the enhanced environment. The memory may include instructions causing the processor to output, to the first interface, the enhanced environment and a position of the first user, the instrument and model avatars in the enhanced environment. The memory may include instructions causing the processor to output, to the first interface, an option for selecting an action of the model avatar in the enhanced environment. The memory may include instructions causing the processor to receive, from the first interface, a selection of a first action of the model avatar in the enhanced environment. The memory may include instructions causing the processor to generate, in the enhanced environment, an action of the model avatar based on the selection of the model avatar in the enhanced environment. The memory may include instructions causing the processor to output, to the first and second interfaces, the action of the model avatar in the enhanced environment.

In some embodiments of the systems and methods, the memory may include instructions causing the processor to receive, from the position sensors, dynamic second user and instrument position data representative of a dynamic movement of at least one of the second user and instrument. The memory may include instructions causing the processor to generate, in the enhanced environment, movement of the second user and the instrument avatars based on dynamic movement of the second user and the instrument. The memory may include instructions causing the processor to selectively modify, based on at least one of the position data and dynamic movement of at least one of the second user and the instrument, a second action of the avatar. The memory may include instructions causing the processor to receive, from an audio input device, an audible command of the second user and to selectively modify, based at least in part on the audible command, a second action of the model avatar. The memory may include instructions causing the processor to receive, from a retina sensor (or other like sensor), a visual indication (or gaze) of a user that identifies a command, such as taking a subject's license, handcuffing, or sending ID information to dispatch, etc.

The memory may include instructions causing the processor to output, with the first interface, an option for selecting a second action of the model avatar. The memory may include instructions causing the processor to receive a selection by the first user of a second action of the model avatar in the enhanced environment.

The memory may include instructions causing the processor to selectively identify a bias of at least one of the first and second users. The memory may include instructions causing the processor to selectively identify a bias of the second user based at least in part on one of the dynamic movements and the audible command and to selectively modify, based on the identified bias, the second action. The memory may include instructions causing the processor to selectively identify a bias of the first user based at least in part on one of the selected second actions of the model avatar and to selectively modify, based on the identified bias, the second action. The memory may include instructions causing the processor to receive, from a sensor associated with the second user, a second user measurement and where the second user measurement is at least one of a vital sign of the user, a respiration rate of the user, a heart rate of the user, a temperature of the user, an eye dilation, a metabolic marker, a biomarker, and a blood pressure of the user. The memory may include instructions causing the processor to identify, based on the second user measurement, a bias of the second user.

In some embodiment of the systems and methods, the memory may include instructions causing the processor to output, to a first interface in communication with a first user, an option for selecting an enhanced environment. The first interface is one of an augmented reality device, a virtual reality device, a mixed reality device, and an immersive reality device configured to present the enhanced environment. The memory may include instructions causing the processor to receive, from the first interface, a selection of the enhanced environment. The memory may include instructions causing the processor to generate an enhanced environment based on the selection. The memory may include instructions causing the processor to generate, in the enhanced environment, a model avatar. The memory may include instructions causing the processor to generate, in the enhanced environment, a user avatar representative of the first user. The memory may include instructions causing the processor to receive, from position sensors, first user position data representative of a location of the first user. The memory may include instructions causing the processor to generate, from the first user position data, a position of the user avatar in the enhanced environment. The memory may include instructions causing the processor to generate, in the enhanced environment, an instrument avatar representative of an instrument selected by and associated with the first user. The memory may include instructions causing the processor to receive, from position sensors, instrument position data representative of a location of the instrument. The memory may include instructions causing the processor to generate, from the instrument data, a position of the instrument avatar in the enhanced environment. The memory may include instructions causing the processor to output, to the first interface, the enhanced environment and a position of the user, instrument and model avatar in the enhanced environment. The memory may include instructions causing the processor to generate, in the enhanced environment, an action of the model avatar. The memory may include instructions causing the processor to output, to the first interface, the action of the model avatar in the enhanced environment.

In some embodiment of the systems and methods, the memory may include instructions causing the processor to receive, from the position sensors, dynamic first user and instrument position data representative of a dynamic movement of at least one of the first user and instrument. The memory may include instructions causing the processor to generate, in the enhanced environment, movement of the user and instrument avatars based on dynamic movement of the first user and the instrument. The memory may include instructions causing the processor to output, in the first interface, the movement of the user and the instrument avatars. The memory may include instructions causing the processor to selectively modify, based on at least one of the position data and dynamic movement of at least one of the first user and the instrument, a second action of the avatar. The memory may include instructions causing the processor to receive, from an audio input device, an audible command of the first user. The memory may include instructions causing the processor to selectively modify, based at least in part on the audible command, a second action of the model avatar.

The memory may include instructions causing the processor to selectively identify a bias of the first user. The memory may include instructions causing the processor to selectively identify a bias of the second user based at least in part on one of the enhanced environments, dynamic movement, and the audible command. The memory may include instructions causing the processor to selectively modify, based on the identified bias, a third action of the model avatar. The memory may include instructions causing the processor to receive, from a sensor associated with the second user, a first user measurement and where the second user measurement is at least one of a vital sign of the user, a respiration rate of the user, a heart rate of the user, a temperature of the user, an eye dilation, a metabolic marker, a biomarker, and a blood pressure of the first user. The memory may include instructions causing the processor to identify, based on the first user measurement, a bias of the first user.

The enhanced environment of the present systems and methods may include a digital object configured to be presented to the user such that the user perceives the digital object to be overlaid onto a real-world environment. The digital object may include information pertaining to the position of the model avatar, instrument, other objects or structures relative to the user, an image or video (e.g., or a person, landscape, and/or other suitable image or video), sound or other audible component, other suitable digital object, or a combination thereof. A part or all of the enhanced environments may be provided through virtual reality (e.g., 3D or other dimensional reality). The virtual reality component includes at least a portion of a virtual world or environment, such as a sound component, a visual component, a tactile component, a haptic component, other suitable portion of the virtual world, or a combination thereof.

In some embodiments, the systems and methods described herein may be configured to generate an enhanced environment using any number of inputs. In some embodiments, the inputs may include every aspect of the enhanced environments (e.g., instruments, user, model avatar, building, etc.) or only a portion of the enhanced environments. In some embodiments, the selection of an individual element of the enhanced environment may include multiple selections. For example, when selecting a model avatar, the model avatars, races, sex, height, weight, clothing, or any other characteristic may be selected as an input into the enhanced environment. While the user engages the enhanced environment, the enhanced environment may be configured to enhance the experience perceived by the user.

In some embodiments of the systems and methods, the enhanced environment may be presented to the user, while the user uses an instrument such as a gun, Taser, baton, etc., in reality and simulated in the enhanced environments. The enhanced environment may provide images, video, sound, tactile feedback, haptic feedback, and/or the like which the user may respond to. The enhanced environment may be configured to encourage or trick the user to perform a certain action to test the user's ability. The enhanced environment may also cooperate with the instrument to provide haptic feedback, through the instrument. For example, the enhanced environment may present the model avatar striking the user's instrument, which may be felt by-way-of, a haptic feedback in the instrument held by the user.

In some embodiments, the systems and methods described herein may be configured to output at least one aspect of the enhanced environment to an interface configured to communicate with a user. The interface may include at least one enhanced reality device configured to present the enhanced environment to the user. The at least one enhanced reality device may include an augmented reality device, a virtual reality device, a mixed reality device, an immersive reality device, or a combination thereof. The augmented reality device may include one or more speakers, one or more wearable devices (e.g., goggles, gloves, shoes, body coverings, mechanical devices, helmets, and the like), one or more restraints, a seat, a body halo, one or more controllers, one or more interactive positioning devices, other suitable augmented reality devices, one or more other augmented reality devices, or a combination thereof. For example, the augmented reality device may include a display with one or more integrated speakers. Speakers may also be in communication with a second user and facilitate audio transmission between users in remote facilities.

The virtual reality device may include one or more displays, one or more speakers, one or more wearable devices (e.g., goggles, gloves, shoes, body coverings, mechanical devices, helmets, and the like), one or more restraints, a seat, a body halo, one or more controllers, one or more interactive positioning devices, other suitable virtual reality devices, or a combination thereof. The mixed reality device may include a combination of one or more augmented reality devices and one or more virtual reality devices. The immersive reality device may include a combination of one or more virtual reality devices, mixed reality devices, augmented reality devices, or a combination thereof.

In some embodiments, the enhanced reality device may communicate or interact with the instrument. For example, at least one enhanced reality device may communicate with the instrument via a wired or wireless connection, such as those described herein. The at least one enhanced reality device may send a signal to the instrument to modify characteristics of the instrument based on the at least one enhanced component and/or the enhanced environment. Based on the signal, a controller or processor of the instrument may selectively modify characteristics of the instrument.

In some embodiments, the systems and methods described herein may be configured to selectively modify the enhanced environment. For example, the systems and methods described herein may be configured to determine whether the enhanced environment is having a desired effect on the user. For example, the systems and methods may monitor various physical aspects of the user such as heart rate, blood pressure, pupil dilation, etc. in order to determine the “fight-or-flight” response of the user. The systems and methods described herein may be configured to modify the enhanced environment, in response to determining that the enhanced environment is not having the desired effect, or a portion of the desired effect, or a combination thereof, to attempt to achieve the desired effect or a portion of the desired effect.

In some embodiments, the systems and methods described herein may determine that the enhanced environment is having the desired effect on the user and may modify the enhanced environment, or a portion of the desired effect, or a combination thereof, to motivate the user to act or cease to act in a particular way or to achieve an alternative desired effect or a portion of the alternative desired effect (e.g., the systems and methods described herein may determine that the user is capable of handling a more intense enhanced environment or need to lessen the intensity for optimal training).

In some embodiments, and without limiting the foregoing, a “user” may be a human being, a robot, a virtual assistant, a virtual assistant in virtual and/or augmented reality, or an artificially intelligent entity, such entity including a software program, integrated software and hardware, or hardware alone. The systems and methods described herein may be configured to write to an associated memory, for access at the computing device of the user. The systems and methods may provide, at the computing device of the user, the memory. For example, the systems and methods described herein may be configured to provide information of the enhanced environment to an interface configured to alter the enhanced environment based on a selection of a user, such as a trainer. The interface may include a graphical user interface configured to provide options for selection by the trainer/user and receive input from the trainer/user. The interface may include one or more input fields, such as text input fields, dropdown selection input fields, radio button input fields, virtual switch input fields, virtual lever input fields, audio, haptic, tactile, biometric, or otherwise activated and/or driven input fields, other suitable input fields, or a combination thereof.

In some embodiments, the trainer may review an enhanced environment selected for training and determine whether to modify the enhanced environment, at least one aspect of the enhanced environment (e.g., location, model avatar, etc.), and/or one or more characteristics of the enhanced environment (e.g., sex or race of the model avatar, etc.). For example, the trainer may review the training that will occur or is occurring in the enhanced environment and assess the responses of the user to the enhanced environment. In some embodiments, the trainer may select to add additional model avatars to the enhanced environments such that there are multiple model avatars that the trainee has to deal with. Such an example is useful in training for riot situations. In some embodiments, there may be multiple trainers that are controlling multiple model avatar suspects in the enhanced environment, and the multiple model avatars may be controlled to act with the same purpose or differing purposes (e.g., model avatars may attack each other), and the trainee has to determine in real-time or near real-time how to handle the multiple model avatars to provide safety. In some embodiments, there may be multiple users participating in the same simulation including the enhanced environment, and the multiple users may communicate with each other over a networked communication channel. Further, the trainer or trainers may communicate to each of the multiple users over the networked communication channel. Thus, the ratio of model avatars and user avatars in the enhanced environment may be one to one, one to many, many to one, or many to many.

The trainer may compare the following (i) expected information, which pertains to the user's expected or predicted performance when the user actually uses the enhanced environment and/or instrument to (ii) a measured and proportional course of action taken by the user in the enhanced environment.

The expected information may include one or more vital signs of the user, a respiration rate of the user, a heart rate of the user, a temperature of the user, a blood pressure of the user, other suitable information of the user, or a combination thereof. The trainer may determine that the enhanced environment is having the desired effect and the users response is measured and proportional, and if one or more parts or portions of the measurement information are within an acceptable range associated with one or more corresponding parts or portions of the expected information. Alternatively, the trainer may determine that the enhanced environment is not having the desired effect (e.g., not achieving the desired effect or a portion of the desired effect) and the user's response is not measured and proportional, and if one or more parts or portions of the measurement information are outside of the range associated with one or more corresponding parts or portions of the expected information. The trainer may determine whether the user selected an appropriate and proportional instrument (e.g., weapon), used appropriate deescalating techniques, or verbally engaged the model avatar appropriately, and in real-time adjust the enhancement environment.

The trainer may receive and/or review the user's enhanced environment continuously or periodically while the user interacts with the enhanced environment. Based on one or more trends indicated by the continuously and/or periodically received information, the trainer may modify a present or feature enhanced environment, and/or to control the one or more characteristics of the enhanced environment. For example, the one or more trends may indicate an increase in heart rate or other suitable trends indicating that the user is not performing properly and/or that performance is not having the desired effect. Additionally, or alternatively, the one or more trends may indicate an unacceptable increase in characteristic of the user (e.g., perspiration, blood pressure, heart rate, eye twitching, etc.) or the recognition of other suitable trends indicating that the enhanced environment is not having the desired effect.

In some embodiments, the systems and methods described herein may be configured to use artificial intelligence and/or machine learning to assign or modify an enhanced environment. The term “adaptive environment” may refer to an enhanced environment that is dynamically adapted based on one or more factors, criteria, parameters, characteristics, or the like. The one or more factors, criteria, parameters, characteristics, or the like may pertain to the user (e.g., heart rate, blood pressure, perspiration rate, eye movement, eye dilation, blood oxygen level, biomarker, vital sign, temperature, or the like), the instrument, or past or current user, or others, interaction with the enhanced environment.

In some embodiments, the systems and methods described herein may be configured to use artificial intelligence engines and/or machine learning models to generate, modify, and/or control aspects of the enhanced environment. For example, the artificial intelligence engines and/or machine learning models may identify the one or more enhanced components based on the user, an action of the user, or the enhanced environment. The artificial intelligence engines and/or machine learning models may generate the enhanced environment using one or more enhanced components. The artificial intelligence engines and/or machine learning models may analyze subsequent data and selectively modify the enhanced environment in order to increase the likelihood of achieving desired results from the user performing in the enhanced environment while the user is interacting with the enhanced environment. Further, the artificial intelligence engines and/or machine learning models may identify weaknesses in performance of the user in past simulations using the enhanced environment, and generate enhanced environments that focus on those weaknesses (e.g., de-escalation techniques for people of a certain race or gender) in subsequent simulation. Such techniques may strengthen and improve the user's performance in those simulations.

In some embodiments, characteristics of the user, including data corresponding to the user responses/actions in the enhanced environment, may be collected before, during, and/or after the user enters an enhanced environment. For example, any or each of the personal information, the performance information, and the measurement information may be collected before, during, and/or after a user interacts with an enhanced environment. The results (e.g., improved performance or decreased performance) of the user responses in the enhanced environment may be collected before, during, and/or after the user engages the enhanced environment.

Each characteristic of the user, each result, and each parameter, setting, configuration, etc. may be time-stamped and may be recorded and replayed from any angle. Such a technique may enable the determination of which steps in the enhanced environment lead to desired results (e.g., proportional and measured response) and which steps lead to diminishing returns (e.g., disproportional and unmeasured response). The recording and/or replay may be viewed from any perspective (e.g., any user perspective or any other perspective) and at any time. In addition, the recording and/or replay may be viewed from any user interface.

Data may be collected from the processor and/or any suitable computing device (e.g., computing devices where personal information is entered, such as the interface of the computing device described herein, an interface, and the like) over time as the user uses the systems and methods to train. The data that may be collected may include the characteristics of the user, the training performed by the user, the results of the training, any of the data described herein, any other suitable data, or a combination thereof.

In some embodiments, the data may be processed to group certain users into cohorts. The user may be grouped by people having certain or selected similar characteristics, responses, and results of performing in a training.

In some embodiments, an artificial intelligence engine may include one or more machine learning models that are trained using the cohorts, i.e., more than one user in the enhanced environment. In some embodiments, the artificial intelligence engine may be used to identify trends and/or patterns and to define new cohorts based on achieving desired results from training and machine learning models associated therewith may be trained to identify such trends and/or patterns and to recommend and rank the desirability of the new cohorts. For example, the one or more machine learning models may be trained to receive an input characteristic representative of a characteristic of a user based on skill level (e.g., a rookie versus an expert). The machine learning models may match a pattern between the characteristics of the new user and an input characteristic and thereby assign the new user to the particular cohort.

As may be appreciated, the characteristics of the new user may change as the new user trains. For example, the performance of one user may improve quicker than expected for people in the cohort to which the new user is currently assigned. Accordingly, the machine learning models may be trained to dynamically reassign, based on the changed characteristics, the new user to a different cohort that includes users having characteristics similar to the now-changed characteristics of the new user. For example, a new user skilled in knowing when to use lethal force may be better suited for de-escalation training over another user who is stronger in de-escalation and weaker in using lethal force.

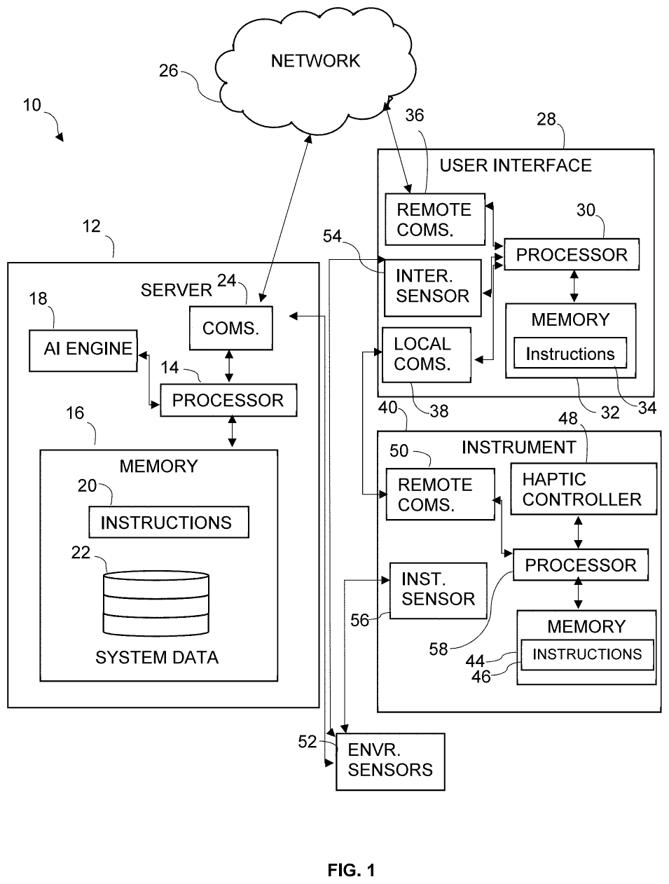

FIG. 1 generally illustrates a block diagram of a computer-implemented system 10 and devices for providing an immersive and response reality, hereinafter called “the system.” The system 10 may include a server 12 that may have a processing device or processor 14, memory 16, an artificial intelligence engine 18, and a communication interface 20. The memory 16 may couple and communicate with the processors 14. The server 10 may be configured to store (e.g., write to an associated memory) and to provide system data 22 related to the immersive and response reality or enhanced environment. More specifically, the memory 16 may provide machine-readable storage of computer readable instructions 20, and the system data 22 related to the enhanced environment. The memory 16 may communicate to and cause the processor 14 to execute the instructions 20 to generate and present the enhanced environment to a user.

The server 12 may include one or more computers and may take the form of a distributed and/or virtualized computer or computers. The server 12 may also include a first communication interface 24 configured to communicate with a first network 26. In some embodiments, the first network 26 may include wired and/or wireless network connections such as Wi-Fi, Bluetooth, ZigBee, Near-Field Communications (NFC), cellular data network, etc. The server 12 is configured to store data regarding one or more enhanced environments, such as an immersive and response environment for training of law enforcement officers using interactive avatars. For example, the memory 16 includes a system data store configured to hold the system data 22, such as data pertaining to an enhanced environment, avatars or instruments for displaying in the enhanced environment, and many other features or elements of the enhanced environment, etc. The server 12 is also configured to store data regarding performance by a user in the enhanced environment. For example, the memory 16 includes recordings of a user's actions in response to the enhanced environment, biases of the user, measurements of the users skill level (e.g., beginner or experienced user, or placement of a user in a specific cohort), among other data related to the enhanced environment. In some embodiments, the bias may be detected based on a specific gender, ethnicity, etc., prior user interaction with a video simulator or standalone platform (e.g., a virtual reality platform designed to identify a bias).

Additionally, or alternatively, the user's performance or any other characteristic, may be stored in the system data 22 and the server 12 (using the memory 16 and processor 14) may use correlations and other statistical or probabilistic measures to enable the server 12 to modify the enhanced environment. For example, the server 12 may provide, to the user, certain selected enhanced environments to challenge or reinforce past performance in an enhanced environment or based on a user's placement in a cohort. The server 12 may also modify an enhanced environment based on the user's performance in real-time as the user response to the enhanced environment or based on a user's current, past or modified cohort, or any other measurement. There is no specific limit to the number of different cohorts of users, other than as limited by mathematical combinatorial and/or partition theory.

In some embodiments, the server 12 may include and execute an artificial intelligence (AI) engine 18. In some embodiments, the AI engine 18 may reside on another component (e.g., a user interface) depicted in FIG. 1 or be located remotely and configured to communicate with the network 26. The AI engine 18 may use one or more machine learning models to perform any element of the embodiments disclosed herein.

The server 12 may include a training engine (not shown in the FIGS.) capable of generating or more machine learning models, and thereby, the AI engine 18. The machine learning models may be generated by the training engine and may be implemented in computer instructions executable by one or more processors of the training engine and/or the server 12. To generate the one or more machine learning models, the training engine may train the one or more machine learning models. The one or more machine learning models may be used by the AI engine 18.

The training engine may be a rackmount server, a router computer, a personal computer, a portable digital assistant, a smartphone, a laptop computer, a tablet computer, a netbook, a desktop computer, an Internet of Things (IoT) device, any other suitable computing device, or a combination thereof. The training engine may be cloud-based or a real-time software platform, and it may include privacy software or protocols, and/or security software or protocols.

In some embodiments, the AI engine 18 may be trained to identify any characteristic of a user engaged with or otherwise using the system 10. For example, the AI engine 18 may be trained to identify a response, or part of a response, of the user to the enhanced environment. The AI engine 18 may also be trained to identify specific characteristics of any user engaged with or otherwise using the system 10. One characteristic may be a bias of the user, such as a user bias to a race, sex of a model avatar presented in the enhanced environment.

To train the AI engine 18, a training data set may be used and the training data set may include a corpus of the characteristics of the people that have or are currently using the system 10. The training data set may rely on current, past, or predicted use of the system 10. For example, the training data may rely on real world environments advantageous for training an user in an enhanced environment. Such real word environment for training law enforcement officers may include the environment the officer engaged during past active shooter situations, or encounters with a mentally ill individual. The training data may rely on action taken by officers, and the response of the active shooter or mentally ill individual. The training data may rely on any situation, characteristic of a situation, scenery, number of active shooters, etc. The training data may be relied on by the AI engine 18 to communicate with the processor 14 to cause the processor to modify, at any time, the enhanced environment presented to a user.

In some embodiments, the AI engine 18 may comprise a single level of linear or non-linear operations (e.g., a support vector machine [SVM]) or a deep network, i.e., a machine learning model comprising multiple levels of non-linear operations. Examples of deep networks are neural networks including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

In some embodiments, the system 10 includes a user interface 28 in communication with a user. The user interface 28 may include one of an augmented reality device, a virtual reality device, a mixed reality device, and an immersive reality device configured to present the enhanced environment. The user interface 28 may be a computer or smartphone, or a phablet, such as an iPad, an iPhone, an Android device, or a Surface tablet, which is held manually by a user.

In some embodiments, the user interface 28 may be configured to provide voice-based functionalities, with hardware and/or software configured to interpret spoken instructions by a user. The system 10 and/or the user interface 28 may include one or more microphones facilitating voice-based functionalities. Advantages to the present disclosure, the voice-based functions of the system 10 may rely on networked microphones to simplify communication between one or more users and/or the system 10. The network microphones may facilitate communication between any user directly (e.g., direct audio communication outside the enhanced environment) or indirectly (e.g., audio communication is communicated through the enhanced environment). In some embodiment, the system 10 and/or user interface 28 may include functionality provided by or similar to existing voice-based assistants such as Siri by Apple, Alexa by Amazon, Google Assistant, or Bixby by Samsung. The user interface may include other hardware and/or software components and may include one or more general purpose devices and/or special-purpose devices.

The user interface 28 may include a display taking one or more different forms including, for example, a computer monitor or display screen on a tablet, a smartphone, or a smart watch. The display may include other hardware and/or software components such as projectors, virtual reality capabilities, or augmented reality capabilities, etc. The display may incorporate various different visual, audio, or other presentation technologies. For example, the user interface 28 may include a non-visual display, such as an audio signal, which may include spoken language and/or other sounds such as tones, chimes, melodies, and/or compositions, which may signal different conditions and/or directions. The display may comprise one or more different display screens presenting various data and/or interfaces or controls for use by the healthcare provider. The display may include graphics, which may present the enhanced environment and/or any number of characteristics of the enhanced environment.

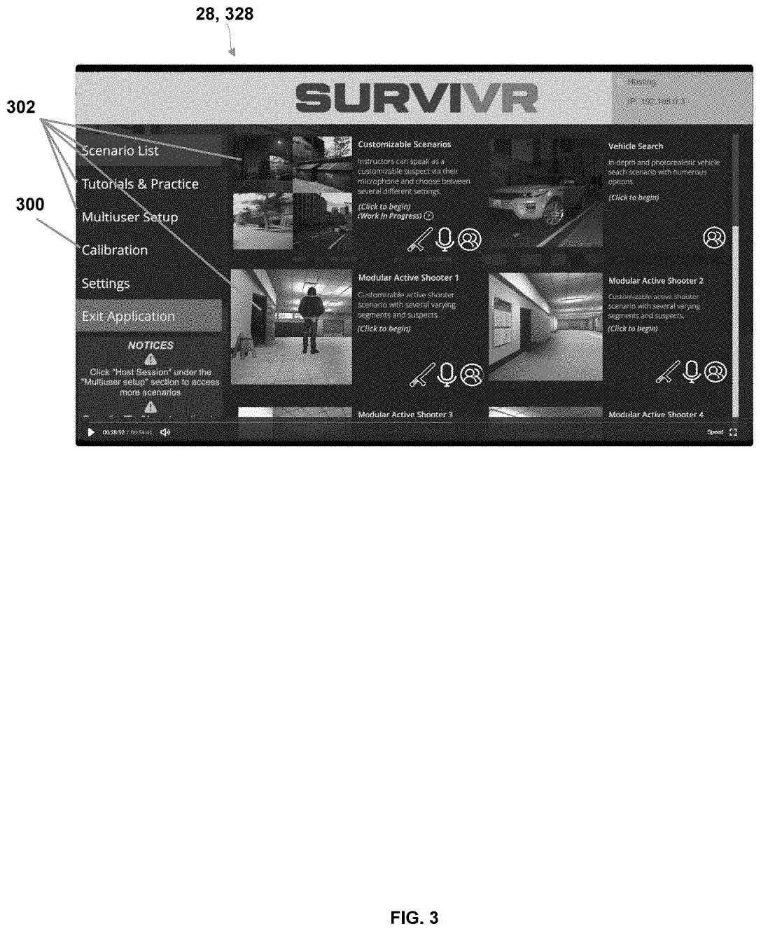

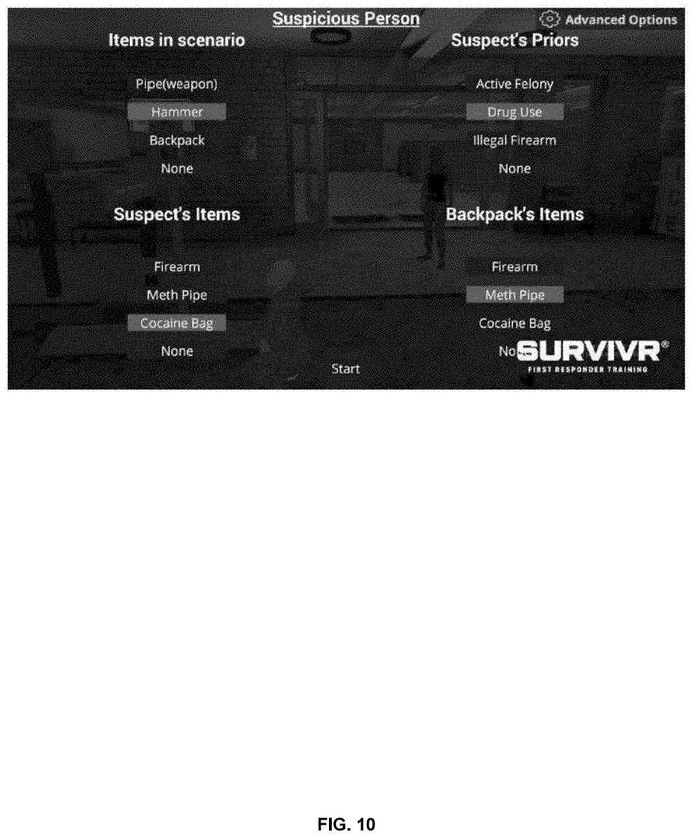

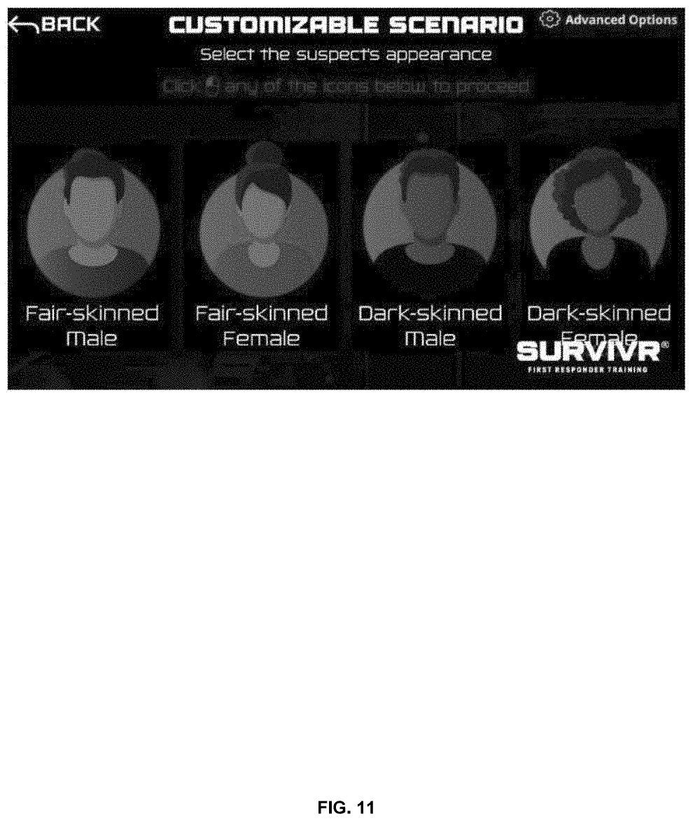

The user interface 28 may include a second processor 30 and a second memory 32 having machine-readable storage including second instructions 34 for execution by the second processor 32. In some embodiments, the system may include more than one user interface 28. For example, the system 10 may include a first user interface in communication with a first user, such as a supervising officer. FIGS. 3-5 and 9-12 present several examples of an enhanced environment presented to a supervising officer. The system 10 may also include a second user interface in communication with a second user, such as a training officer. In some embodiments, the first and second user interfaces may be the same as or differing from user interfaces 28. In some embodiments, when the user interfaces 28 are the same, the system 10 may provide the same, or differing, enhanced environment to more than one user and be configured to allow more than one user to respond to the enhanced environment.

The second memory 32 also includes local data configured to hold data, such as data pertaining to the display of an enhanced environment to a user. The second memory 32 may also hold data pertaining to a user settings and/or preference of the user interface, such as data representing a user's position of a microphone, speaker, or display. In some embodiments, the second memory 32 can provide instructions to the processor 30 to automatically adjust one more of the microphone, speaker or display to a setting or preference of the user.

In some embodiments, the user interface 28 may include a remote communication interface 36 configured to communicate with the second processor 14 and the network 26. The remote communication interface 36 facilitates communication, through the network 26, with the server 12. The remote communication interface 36 facilitates receiving from and sending data to the server 12 related to the enhanced environment. In some embodiments, the user interface 28 may include a local communication interface 38 configured to communicate with various devices of the system 10, such as an instrument 40 associated with the user. The local and remote communication interfaces 36, 38 may include wired and/or wireless communications. In some embodiments, the local and remote communication interfaces 36, 38 may include a local wireless network such as Wi-Fi, Bluetooth, ZigBee, Near-Field Communications (NFC), cellular data network, etc.

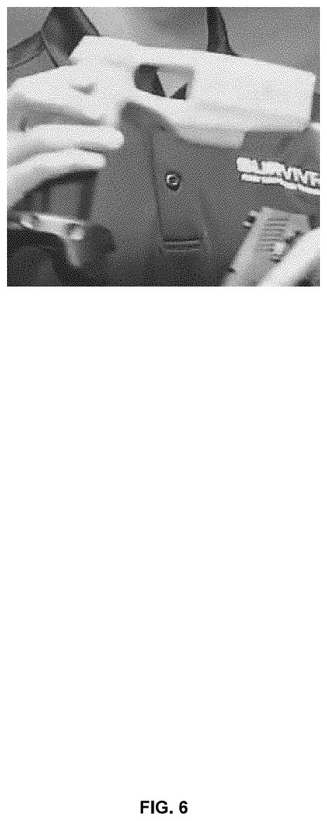

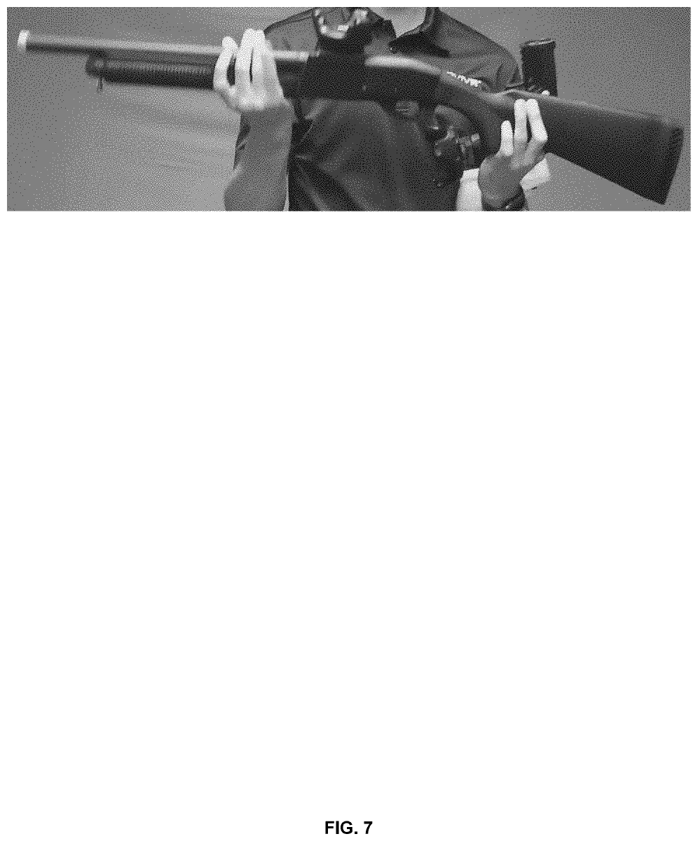

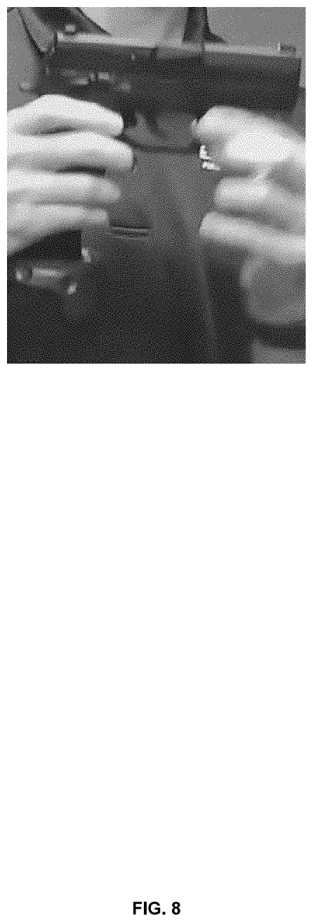

The system 10 may also include an instrument 40 associated with a user. The instrument 40 may replicate or be any tool. For example, when the system is used for training a law enforcement officer or a civilian for self-defense, the instrument may replicate or be a shotgun, rifle, pistol, Taser, baton, or any other instrument used by a law enforcement officer. FIGS. 6-8 shown embedment of the instrument 40 a Taser, handgun and shotgun. In some embodiments, the instrument 40 may replicate a tool and include a third processor 58 and a third memory 44 having machine-readable storage including third instructions 46 for execution by the third processor 58. In some embodiments, the system 10 may include more than one instrument 40. For example, the system 10 may include a first instrument associated with a first user, such as a first training officer. The system 10 may also include a second instrument associated with a second user, such as a partner-in-training officer. In some embodiments, the first and second instruments may be the same or different instruments 40.

The third memory 44 also includes local data configured to hold data, such as data pertaining to haptic feedback. The third memory 44 may also hold data pertaining to a user settings and/or preference of the instrument 40. In some embodiments, the third memory 44 can provide instructions to the third processor 58 to automatically adjust one or more settings and/or preference of the instrument 40. In some embodiments, the instrument may include a haptic controller 48 in communication with the third processor 58 and configured to control a haptic element of the instrument. The haptic element may be a weight distribution, vibration, or other haptic feedback control to the user.

In some embodiments, the instrument 40 may include an instrument remote communication interface 50 configured to communicate with the third processor 58 and the local communication interface 38 of the user interface 28. The instrument remote communication interface 50 facilitates communication, through the user interface 28 and network 26, with the server 12. In some embodiments, the instrument remote communication 50 may communicate directly with the network 26 and or server 12. The instrument remote communication 50 facilitates receiving from and sending data to the server 12 related to the enhanced environment. The instrument remote communication interface 50 may include wired and/or wireless communications. In some embodiments, the instrument remote communication interface 50 may include a local wireless network such as Wi-Fi, Bluetooth, ZigBee, Near-Field Communications (NFC), cellular data network, etc.

In some embodiments, the system 10 includes environmental sensors 52 configured to sense, and communicate to the server 12, dynamic movement of the user and/or instrument. The environmental sensors 52 may be any of the well-known sensors for capturing dynamic movement of an object, such as, for example a sensor for identifying a location of and measuring dynamic movement of a diode associated with the user, user interface and/or instrument. For example, the environmental sensor 52 may communicate with one or more interface and instrument sensors 54, 56, such as one or more diodes associated with the user interface 28 or instrument 40. The environmental sensor 52 may sense and communicate, in real-time, dynamic movement of the user interface 28 and/or instrument 40. Any sensor referred to herein may be standalone, part of a neural network, a node on the Internet of Things, or otherwise connected or configured to be connected to a physical or wireless network.

In some embodiments, the system 10 may rely on the location of the user, user interface 28, or instrument 40 to customize the enhanced environment. In other words, the enhanced environment may be sized and reflect (proportionally or non-proportionally) a physical space in which the user is located. In some embodiments, the system 10 may present to a user, in the user interface 28, an option to begin a calibration procedure. The system 10 may receive a selection to calibrate the enhanced environment of the user interface 28. The calibration procedure may be used to generate a calibrated view of the enhanced environment. The calibrated view may reflect a physical environment of the user in the enhanced environment. The calibration procedure may be used to reflect, in part or in whole, a physical environment of the user in the enhanced environment. The calibrated view including the reflected physical environment in the enhanced environment may be proportional or non-proportional. The calibrated view may also be used to reflect a perimeter of the physical space and to reflect the perimeter within the enhanced environment that is novel relative to the physical environment of the user. For example, the calibration procedure may rely on “marking” of a physical location and reflecting the marked location in the enhanced environment. The marked location in the physical environment may be reflected in the enhanced environment as being the same (e.g., a wall in the physical environment is reflected as a wall in the enhanced environment) or different (e.g., a wall in the physical environment is reflected as a fence in the enhanced environment).

The calibration procedure may instruct the user to set a controller and/or user interface in a corner of a square physical space and configure the controller and/or user interface to be facing forward towards an opposing corner in the interior of the physical space. A first forward facing view may be saved to the memory 16. The user may repeat this process using the controller and/or user interface in each remaining corner to obtain second, third, and fourth forward facing views from those corners. The forward facing views may be synchronized across each user interface participating in a scenario.

The calibration procedure may be stored as instructions 20 in the memory 16. The memory 16 may communicate the instructions representative of a calibration procedure to the processor 14 and the processor 14 may execute the calibration procedure. The processor 14 may present, in the user interface 28, an option for the user to initiate a calibration procedure. In embodiments with multiple users, the processor 14 may present, in each user interface 28, an option for the user to initiate a calibration procedure. In some embodiments, only one user may initiate a calibration procedure and the calibration procedure would begin for each user. In some embodiments, only one user may initiate the calibration procedure, and the calibrated view that is generated may be transmitted via the network 26 to the other user interfaces to cause each user interface to be synchronously calibrated with the calibrated view.

FIG. 3 illustrates an embodiment of the present disclosure where an option to initiate a calibration procedure 300 is presented, in a display of the user interface 28, to a user. The processor 14 may receive the selection, by the user, to begin the calibration procedure. The processor 14 may initiate the calibration procedure by presenting, in the user interface 28, instructions for positioning, in the physical environment, the user interface 28, an instrument 40, or any other diode, device, or equivalent or similar apparatus. The processor 14 may also present, in the user interface 28, an option for the user to mark the location. For example, the processor 14 may present an option for the user to “mark” a location of walls, chairs, or any other physical object that may impede user movement while the user is immersed in the enhanced environment. The processor 14 may receive the “marked” location. The processor 14 may store the “marked” location in the memory 16 and/or reflect the “marked” location in the enhanced environment. In some embodiments, such as those with multiple users, the calibration procedure may result in a 1:1 special relationship between each user and a respective user avatar.

With reference to FIGS. 1 and 3, in some embodiments of the present disclosure, the server 12 may output, to a first interface 28, 328 in communication with a first user, an option 302 for selecting an enhanced environment. For example, the processor 14 may present in a display of the user interface 28, 328 options, similar to the options shown in FIG. 3, to a user to select a scenario which will be presented in the enhanced environment. The scenario may be customizable, and in the context of training a law enforcement officer, may simulate a vehicle search, active shooter, or engaging a mentally ill individual. Any suitable scenario may be customized to include any type and/or number of suspects in any situation. Further, the objects, items, and weapons included in the scenario may be customized and the position and/or location of the suspects and objects, items, and weapons may be customized.

The processor 14 may also receive, from the first interface, a selection of the enhanced environment. The processors 14 for example, may receive, from the remote communication interface 36 through the network 26, a signal representative of the selection of an enhanced environment, such as a selection representative of the vehicle search shown in FIG. 3. The processor 14 may also generate an enhanced environment based on the selection. The enhanced environment generated by the processor may have the same, similar or different features or element in each time the option is selected. The enhanced environment, however, may also differ by presenting new features or elements but maintain a general theme (e.g., vehicle search).

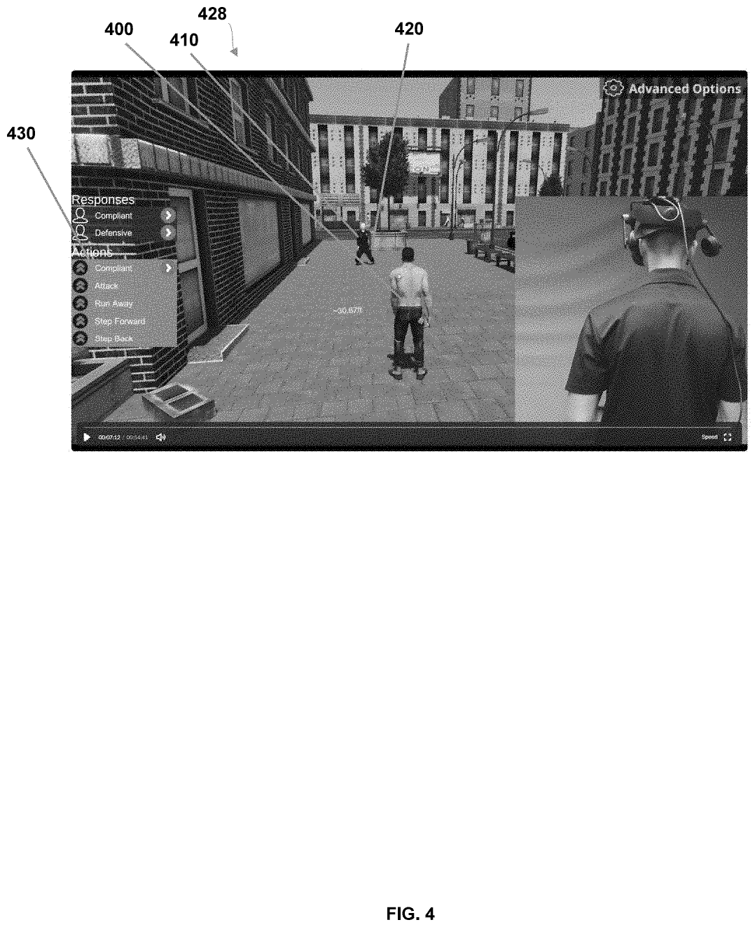

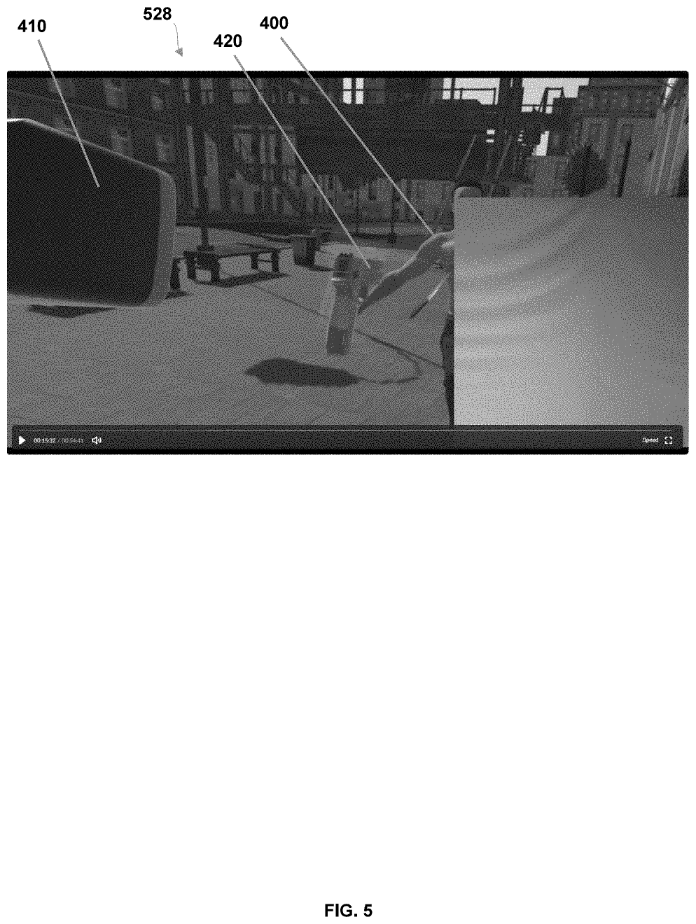

The processor 14 may also generate, in the enhanced environment, a model avatar. The model avatar may be based on the selection of the enhanced environment by the user. For example, if the user selected the option for the enhanced environment to present a mentally ill individual, the model avatar would be a mentally ill individual. FIGS. 4 and 5 illustrate an enhanced environment, displayed in the user interfaces 428, 528, showing a model avatar 400 representative of a mentally ill individual. The processor 14 may generate, in the enhanced environment, a user avatar 410 that is representative of a user (e.g., trainee), also shown in FIGS. 4 and 5.

The processor 14 may receive, from the environmental or position sensors 52, user position data representative of a location of the user. The position sensors 52 may identify a location of the user as being the same as the location of the user interface 28, the instrument 40, a position vest worn by the user, or any other apparatus known in the art to identify a location of the user or an object. The position sensor 52 recognizes the location of the user, the position sensor 52 may send, to the processor 14, data representing the location of the user. The processor 14 may receive and store the data in the memory 16 as user position data. The processor 14 may generate, from the user position data, a position of the user avatar 410 in the enhanced environment.

The processor 14 may also generate, in the enhanced environment, an instrument avatar 420 representative of an instrument 40 selected by and associated with the user. In some embodiments, the position sensors 52 may identify a location of the instrument 40 by identifying diodes coupled to the instrument 40, wireless circuitry providing signals representing the location of the instrument 40, or the like. The position sensor 52 may recognize the location of the instrument 40 by the diodes and the position sensor 52 may send, to the processor 14, data representing a location of instrument 40. The processor 14 may receive the data and store the data in the memory 16 as instrument position data. The processor 14 may generate, from the instrument position data, a position of the instrument avatar 420.

The processor 14 may output, to the interface 28, 328, 428, 528, the enhanced environment and a position of the user, instrument and model avatar in the enhanced environment. The processor 14 may also output the enhanced environment and a position of the user, instrument and model avatar to a second interface 28 of the system (e.g., the enhanced environment and relative positions are displayed on a tablet, or the like, and in virtual reality goggles). The position of each avatar in the enhanced environment may reflect a proportional, or non-proportion, object or user in a physical environment. For example, a second user in the same room as a first user may use a second interface 28 to interact with the enhanced environment. In such instances, a second user avatar may be placed in the enhanced environment. The positions of the second user avatar may be proportional or non-proportional to a relative position between the first and second users in a physical environment, such as a room, and in the enhanced environment.

The processors 14 may generate, in the enhanced environment, an action of the model avatar 420. In some embodiments, the AI engine 18 may selectively provide instructions to the processor 14 representing an action for the model avatar 420 to take. In some embodiments, the memory 16 may provide instructions 20, based on stored data representing an action for the model avatar 420 to take, to the processor 14. In some embodiments, the AI engine or the memory 16 may communicate instructions to the processor 14 to provide an option, to at least one user interface 28, to select an action of the model avatar. For example, in the context of training a law enforcing officer, as user interface 428 associated with a supervising officer may present an option 430 for an action to be taken by the model avatar. FIG. 4 shows example options 430 for action of the model avatar 400 of the mentally ill individual. At the same time, an interface 28 associated with the training officer will not be present with the options. The processor 14 may also receive, from the interface 428 associated with the supervising officer, a selection of a first action of the model avatar in the enhanced environment. In some embodiments, the processor 14 may generate, in the enhanced environment, an action of the model avatar based on the selected action. In some embodiments, the processor 14 may generate, in the enhanced environment, an action of the model avatar based on the instructions from the memory 16 or AI engine 12. The processor 14 may output, to the interfaces 28, 328, 428, 528 etc., the action of the model avatar in the enhanced environment.

In some embodiments of the system 10, the processor may receive, from the position sensors 52, dynamic user and instrument position data representative of a dynamic movement of at least one of the user and instrument. For example, the position data may reflect the dynamic movement of drawing an instrument 40, such as a gun. The processor 14 may generate, in the enhanced environment, movement of the user and the instrument avatars based on the dynamic movement of the second user and the instrument. The processor 14 may also display, in the enhanced environment, the dynamic movement.

In some embodiments, the processor 14 may output, with the interface 28, 328, 438, 528, an option for selecting a second action of the model avatar. The option may be presented in response to the dynamic movement. The processor 14 receives, from the user interface 28, 328, 438, 528, a selection by the first user signal representative of a second action of the model avatar in the enhanced environment. In some embodiments, the processors 14, executing instructions from the AI engine 18 or the memory 16, may selectively modify, based on at least one of the position data and dynamic movement of at least one of the second user and the instrument, a second action of the avatar. In such instances, the AI engine 18 and memory 16, may provide instructions for a second action based on stored or learned data of the user or others.

In some embodiments of the system 10, the processor 14 may receive, from an audio input device, an audible command of the user. The audio input device may be coupled to or separate from the user interface. The processors 14, executing instructions from the AI engine 18 or the memory 16 and at least in part on the audible command or the dynamic movement, may selectively modify a second action of the model avatar. The selective modification may occur before or during the second action of the model avatar.

In some embodiments of the system 10, the processor 14 is further configured to selectively identify a bias of the first user. The processors 14 may be configured to receive, from the AI engine 18 or the memory 16, instructions for selectively identifying a bias of a user (e.g., trainee) based on real-time or stored data associated with the bias. In some embodiments, one or more machine learning models may be trained to identify the bias. The machine learning models may be trained using training data that includes inputs of certain actions, words, etc. that users perform, say, etc. to suspects of certain races, genders, ages, etc. that are indicative of bias and outputs that identify the bias. The instructions may identify a bias based on real-time or stored data based, at least in part, on the dynamic movement, the audible command, or a selection by a user. The processors 14 may selectively modify, based on the identified bias, the second, third, or subsequent action of the model avatar.

In some embodiments, the system 10 includes a sensor associated with a user where the sensor is configured to measure at least one of a vital sign of the user, a respiration rate of the user, a heart rate of the user, a temperature of the user, an eye dilation, a metabolic marker, a biomarker, and a blood pressure of the user. The processor 14 may receive, from the sensor associated with the user, a user measurement. The user measurement may be at least one of a vital sign of the user, a respiration rate of the user, a heart rate of the user, a temperature of the user, an eye dilation, a metabolic marker, a biomarker, and a blood pressure of the user. The processor 10 may be configured to receive, from the AI engine 18 or the memory 16, instructions for selectively identifying a bias of the user based on the user measurement.

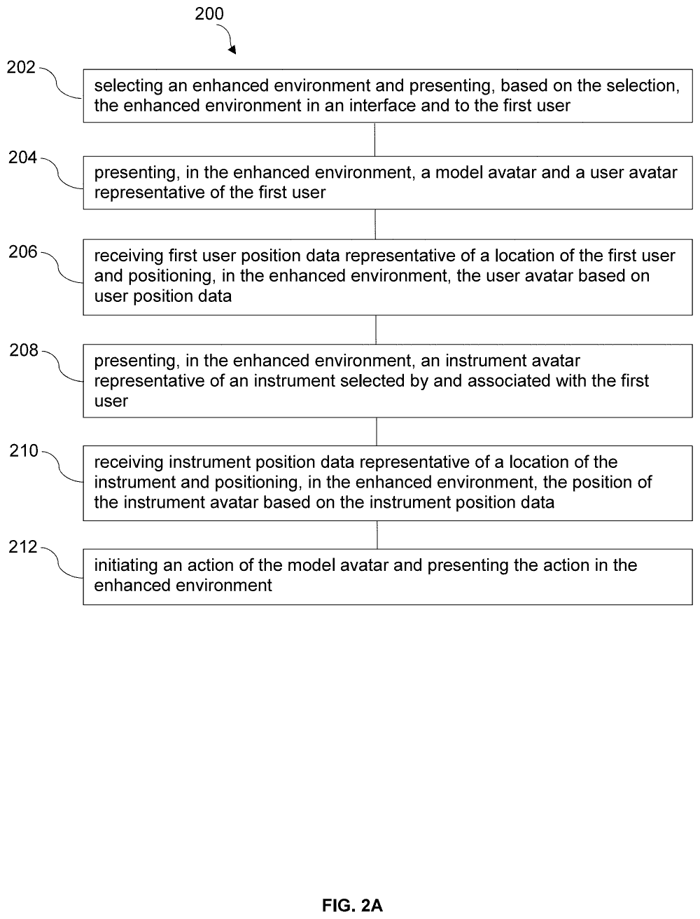

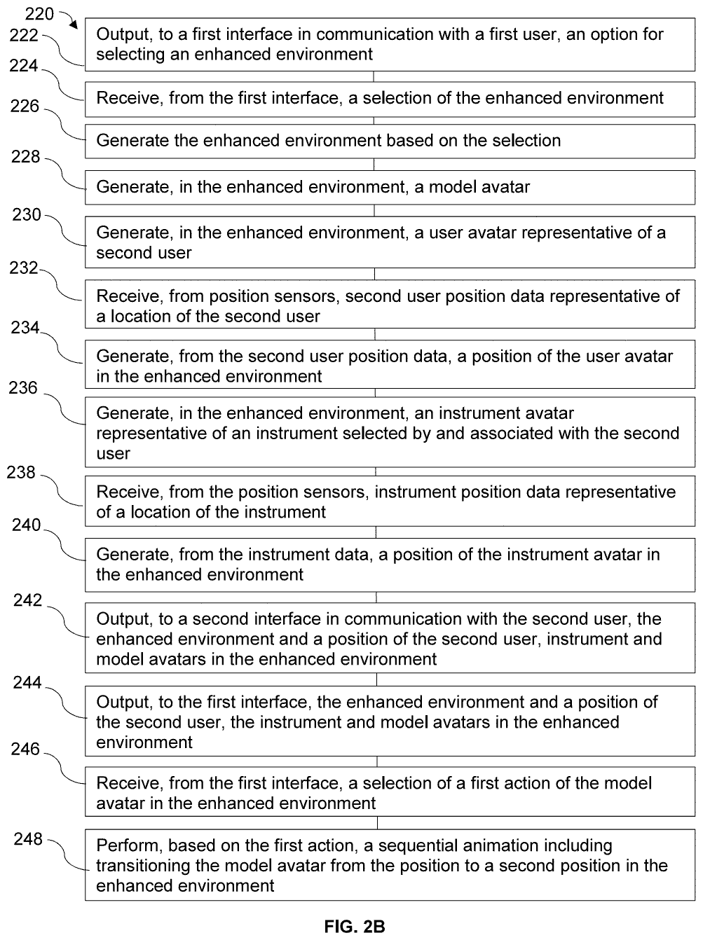

According to the principles of the present disclosure, FIG. 2A is a flow diagram generally illustrating a method 200 providing an immersive and response reality. The method 200 is performed by processing logic that may include hardware (circuitry, dedicated logic, etc.), software (such as is run on a general-purpose computer system or a dedicated machine), or a combination of both. The method 200 and/or each of its individual functions, routines, subroutines, or operations may be performed by one or more processors of a computing device (e.g., any component of FIG. 1, or provided in the system 10). In some embodiments, the method 200 may be performed by a single processing thread. Alternatively, the method 200 may be performed by two or more processing threads, each thread implementing one or more individual functions, routines, subroutines, or operations of the methods.

For simplicity of explanation, the method 200 is depicted and described as a series of operations. However, operations in accordance with this disclosure can occur in various orders and/or concurrently, and/or with other operations not presented and described herein. For example, the operations depicted in the method 200 may occur in combination with any other operation of any other method disclosed herein. Furthermore, not all illustrated operations may be required to implement the method 200 in accordance with the disclosed subject matter. In addition, those skilled in the art will understand and appreciate that the method 200 could alternatively be represented as a series of interrelated states via a state diagram or events.

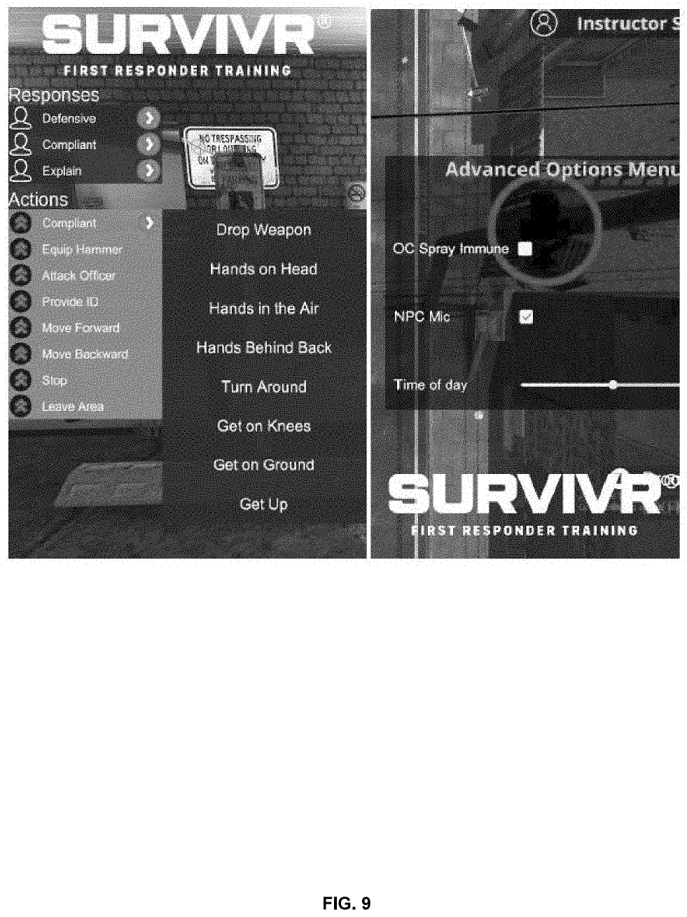

At 202, an enhanced environment may be selected and presented to a first user with an interface, the enhanced environment based on the selection. In some embodiments, the processor may present, in an interface, one or more options for an enhanced reality. In some embodiments, and as illustrated in FIG. 3, the processor may present, in an interface, an option for an enhanced environment which may include specific training scenarios (e.g., engaging a suspect who is mentally ill, engaging an active shooter, etc.). In some embodiments, and as illustrated in FIGS. 9-12, the option for an enhanced environment may include specific elements of the enhanced environment (e.g., an action of the model avatar, characteristic of the model avatar, an instrument associated with a model avatar, etc.). At 204, the processing device may present, in the enhanced environment, a model avatar and a user avatar representative of the first user (FIGS. 4-5).

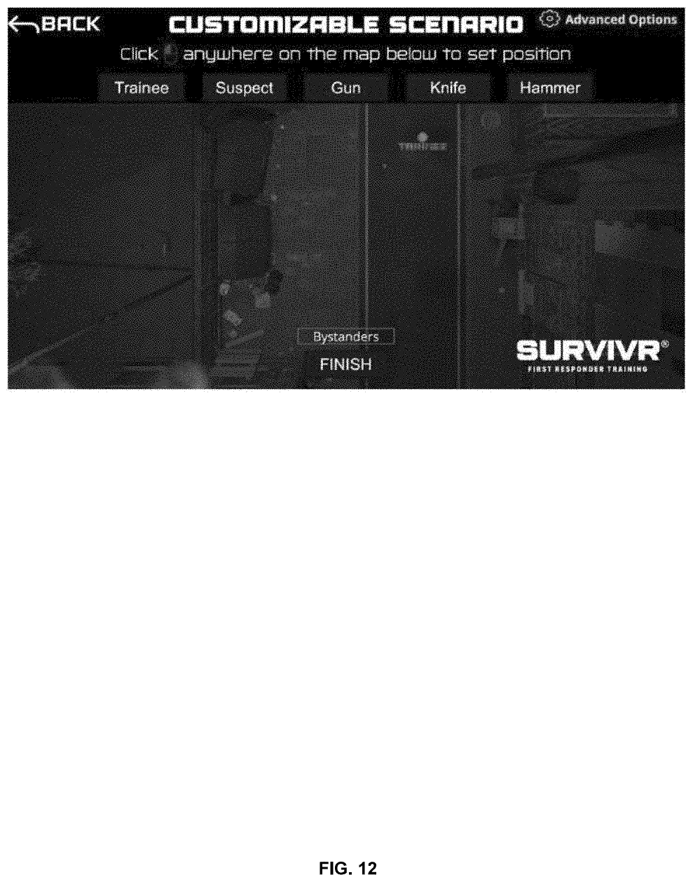

At 206, the processing device may receive first user position data representative of a location of the first user and position, in the enhanced environment, the user avatar based on user position data (see e.g., FIGS. 4 and 12). At 208, the processing device may present, in the enhanced environment, an instrument avatar representative of an instrument selected by and associated with the first user (see e.g., FIG. 4, instrument 420). At 210, the processing device receives instrument position data representative of a location of the instrument and positions, in the enhanced environment, the position of the instrument avatar based on the instrument position data. At 212, the processing device initiates an action of the model avatar and presents the action in the enhanced environment.

According to the principles of the present disclosure, the method 200 may also include receiving dynamic first user and instrument position data representative of a dynamic movement of at least one of the first user and instrument. In some embodiments, the method 200 may include, presenting, in the enhanced environment, movement of the user and instrument avatars based on the dynamic movement of the first user and the instrument. In some embodiments, the method 200 may include selectively modifying, based on at least one of the position and dynamic movement of at least one of the first user and the instrument, a second action of the model avatar. In some embodiments, the method 200 may include receiving an audible command of the first user; and selectively modifying, based at least in part on the audible command, a second action of the model avatar. In some embodiments, the method 200 may include selectively identifying a bias of the first user. In some embodiments, the method 200 may include selectively identifying a bias of the second user based at least in part on one of the enhanced environment, dynamic movement, and the audible command; and selectively modifying, based on the identified bias, a third action of the model avatar. In some embodiments, the method 200 may include receiving a first user measurement where the first user measurement is at least one of a vital sign of the first user, a respiration rate of the first user, a heart rate of the first user, a temperature of the first user, an eye dilation of the first user, a metabolic marker of the first user, a biomarker of the first user, and a blood pressure of the user; and identifying, based on the first user measurement, a bias of the first user. In some embodiments, the first interface of the method 200 is one of an augmented reality device, a virtual reality device, a mixed reality device, and an immersive reality device configured to present the enhanced environment.

According to the principles of the present disclosure, FIG. 2B is a flow diagram generally illustrating a method 220 providing an immersive and response reality. The method 220 is performed by processing logic that may include hardware (circuitry, dedicated logic, etc.), software (such as is run on a general-purpose computer system or a dedicated machine), or a combination of both. The method 220 and/or each of its individual functions, routines, subroutines, or operations may be performed by one or more processors of a computing device (e.g., any component of FIG. 1, or provided in the system 10). In some embodiments, the method 220 may be performed by a single processing thread. Alternatively, the method 220 may be performed by two or more processing threads, each thread implementing one or more individual functions, routines, subroutines, or operations of the methods. The method 220 may be performed in a similar manner as the method 200.

At 222, the processing device may output, to a first interface in communication with a first user, an option for selecting an enhanced environment. At 224, the processing device may receive, from the first interface, a selection of the enhanced environment. At 226, the processing device may generate the enhanced environment based on the selection. At 228, the processing device may generate, in the enhanced environment, a model avatar. At 230, the processing device may generate, in the enhanced environment, a user avatar representative of a second user.

At 232, the processing device may receive, from position sensors, second user position data representative of a location of the second user. At 234, the processing device may generate, from the second user position data, a position of the user avatar in the enhanced environment. At 236, the processing device may generate, in the enhanced environment, an instrument avatar representative of an instrument selected by and associated with the second user.

At 238, the processing device may receive, from the position sensors, instrument position data representative of a location of the instrument. At 240, the processing device may generate, from the instrument data, a position of the instrument avatar in the enhanced environment.

At 242, the processing device may output, to a second interface in communication with the second user, the enhanced environment and a position of the second user, instrument and model avatars in the enhanced environment. At 244, the processing device may output, to the first interface, the enhanced environment and a position of the second user, the instrument and model avatars in the enhanced environment. At 246, the processing device may receive, from the first interface, a selection of a first action of the model avatar in the enhanced environment.

At 248, the processing device may perform, based on the first action, a sequential animation including transitioning the model avatar from the position to a second position in the enhanced environment. In some embodiments, the sequential animation may include a set of movements performed by the model avatar to transition through a set of virtual positions to arrive at the second position. In some embodiments, the sequential animation may include a speed attribute controlled by a selected travel distance for the model avatar to move from the position to the second position. For example, a trainer may use an input peripheral (e.g., mouse, keyboard, controller, microphone, touchscreen) to select the model avatar and to select the second position for the model avatar to move to in the enhanced environment. The speed attribute may be modified based on whether a selected travel distance between the position and the second position exceeds a threshold distance. The speed attribute may be increased (e.g., the model avatar runs) when the selected travel distance between the position and the second position exceeds a threshold distance. In some embodiments, the speed attribute may be decreased (e.g., the model avatar slowly walks) when the selected travel distance between the position and the second position exceeds the threshold distance.

The threshold distance may be configurable and may correspond to a certain distance (e.g., two feet, five feet, ten feet, twenty feet, etc.) of selected movement within the enhanced environment. The distance may be determined based on a difference between the position and the second position (e.g., a difference between two points in an n-dimensional coordinate plane represented by the enhanced environment). In some embodiments, a range of distances may be used to determine when to modify the speed attribute. For example, the range may be configurable and may be, for example, between one and five feet, between five and ten feet, or the like.

In some embodiments, the position may include a vertical standing position of the avatar on a surface (e.g., floor, street, roof, etc.) in the enhanced environment and the second position may include a horizontal prone position of the model avatar on the surface, for example. In this example, the sequential animation may include movements presented in real-time or near real-time of the model avatar bending down to a kneeling position, moving to an a position where its hands and knees are on the surface, lowering its chest to be in contact with the surface and extending their arms and legs to be oriented in the horizontal prone position.

In some embodiments, a type of movement performed by the sequential animation of the model avatar may be controlled based on where the second position for the model avatar to move to is relative to the current position of the model avatar in the enhanced environment. In other words, the sequential animation may be based on a selected location in the enhanced environment. For example, if the second position is selected adjacent to and near (e.g., less than a threshold distance) the current position of the model avatar, then the model avatar may perform a strafing movement. In another example, if the second position is selected adjacent to and far away from the current position of the model avatar, then the model avatar may turn their body towards the second position and walk or run to the second position. Any suitable type of movement may be performed by the model avatar, such as walking, running, strafing, backpedaling, standing up, sitting down, crawling, jumping, fighting (e.g., punching, kicking, pushing, biting, etc.), or the like.

In some embodiments, the method 220 may include the processing device receive a single input from the input peripheral (e.g., a single letter is pressed on a keyboard, a single click is made using a mouse, a single point is touched on a touchscreen, a single command is said into a microphone, etc.). The single input may be associated with a desired emotion for the model avatar to exhibit. The emotion may be angry, sad, happy, elated, depressed, anxious, or any suitable emotion. The model avatar's body may be controlled based on the emotion selected. For example, if the model avatar is sad, the model avatar's body may change to a hunched over position and its head may be angled down to look at the ground in the enhanced environment. Accordingly, based on the single input, the processing device may animate the model avatar to exhibit the desired emotion in the enhanced environment. Further, based on the single input, the processing device may emit audio including one or more spoken words made by the model avatar. The spoken words may be prerecorded or selected from a memory device. In some embodiments, a user (e.g., trainer) may use a microphone to say the spoken words in real-time or near real-time. Thus, the audio may be dynamically emitted during a scenario. In some embodiments, based on the single input, the processing device may synchronize lips of the model avatar to the one or more spoken words. The spoken words may be synchronized by timing the audio with the visual lip movement of the model avatar. For example, one or more synchronization techniques may be used, such as timestamping data of the audio and video of the moving lips of the model avatar to signal when to present each audio and video segment.

In some embodiments, the method 220 may include the processing device concurrently controlling more than one model avatar in the enhanced environment. For example, the processing device may generate, in the enhanced environment, a second model avatar. The processing device may output, to the second interface in communication with the second user, the enhanced environment and the position of the second user, instrument and model avatars and a position of the second model avatar in the enhanced environment. The processing device may output, to the first interface, the enhanced environment and the position of the second user, the instrument and model avatars and the position of the second model avatar in the enhanced environment. The processing device may receive, from the first interface, a selection of an action of the second model avatar in the enhanced environment. The processing device may perform, based on the action, a sequential animation from the position of the model avatar to another position of the second model avatar in the enhanced environment. In some embodiments, the actions of the model avatars may be performed concurrently in real-time or near real-time.

In some embodiments, the method 220 may include the processing device receiving an input associated with a graphical element in the enhanced environment. Responsive to receiving the input, the processing device may display, at the graphical element in the interface, a menu of actions associated with the graphical element. For example, the graphical element may include a virtual car door and the user may use an input peripheral to select the virtual car door. Upon selecting the virtual car door, the menu of actions associated with the virtual car door may be presented in the interface. Dynamically presenting the menu based on the selection may enhance the user interface by controlling the amount of information that is presented in the user interface. In other words, the menu may not be continuously or continually presented in the user interface, the menu may appear when its associated graphical element is selected and the menu may disappear after a selection of an action is made via the menu.

In some embodiments, a scenario configuration mode may be selected by a user using the user interface. A selected scenario may be presented with editing capabilities enabled to allow the user to configure model avatars, objects, items, or any suitable graphical elements in the enhanced environment. For example, the method 220 may include the processing device receiving an input associated with a graphical element in the enhanced environment. In one example, the graphical element may be a virtual car. The processing device may insert the graphical element at the location in the enhanced environment and associate the action with the graphical element. The action may include opening a car door, smashing the windshield, getting in the car, etc.

In some embodiments, the method 220 may include the processing device receiving, from the position sensors, dynamic second user and instrument position data representative of a dynamic movement of at least one of the second user and instrument. The processing device may generate, in the enhanced environment, movement of the second user and the instrument avatars based on dynamic movement of the second user and the instrument.

The processing device may selectively modify, based on at least one of the position data and dynamic movement of at least one of the second user and the instrument, a second action of the model avatar. The processing device may receive, from an audio input device, an audible command of at least one of the first and second users. The processing device may selectively modify, based on at least one of the dynamic movement and the audible command, a second action of the model avatar. The processing device may selectively identify a bias of the second user based at least in part on one of the dynamic movement and the audible command. The processing device may selectively modify, based on the identified bias, the second action.

The processing device may receive, from a sensor associated with the second user, a second user measurement and where the second user measurement is at least one of a vital sign of the user, a respiration rate of the user, a heart rate of the user, a temperature of the user, an eye dilation, a metabolic marker, a biomarker, and a blood pressure of the user. The processing device may identify, based on the second user measurement, a bias of the second user.

The various aspects, embodiments, implementations, or features of the described embodiments can be used separately or in any combination. The embodiments disclosed herein are modular in nature and can be used in conjunction with or coupled to other embodiments.

Consistent with the above disclosure, the examples of assemblies enumerated in the following clauses are specifically contemplated and are intended as a non-limiting set of examples.

### CLAUSES

1. A method for providing an immersive and response reality, the method comprising: selecting an enhanced environment and presenting, based on the selection, the enhanced environment in an interface and to the first user;
presenting, in the enhanced environment, a model avatar and a user avatar representative of the first user;
receiving first user position data representative of a location of the first user and positioning, in the enhanced environment, the user avatar based on user position data;
presenting, in the enhanced environment, an instrument avatar representative of an instrument selected by and associated with the first user;
receiving instrument position data representative of a location of the instrument and positioning, in the enhanced environment, the position of the instrument avatar based on the instrument position data; and
initiating an action of the model avatar and presenting the action in the enhanced environment.

2. The method of clause 1, further comprising:
receiving dynamic first user and instrument position data representative of a dynamic movement of at least one of the first user and instrument;
presenting, in the enhanced environment, movement of the user and instrument avatars based on the dynamic movement of the first user and the instrument.

3. The method of clause 2, further comprising selectively modifying, based on at least one of the position and dynamic movement of at least one of the first user and the instrument, a second action of the model avatar.

4. The method of clause 1, further comprising:
receiving an audible command of the first user; and
selectively modifying, based at least in part on the audible command, a second action of the model avatar.

5. The method of clause 1, further comprising selectively identifying a bias of the first user.

6. The method of clause 4, further comprising:
selectively identifying a bias of the second user based at least in part on one of the enhanced environment, dynamic movement, and the audible command; and
selectively modifying, based on the identified bias, a third action of the model avatar.

7. The method of clause 1, further comprising:
receiving a first user measurement where the first user measurement is at least one of a vital sign of the first user, a respiration rate of the first user, a heart rate of the first user, a temperature of the first user, an eye dilation of the first user, a metabolic marker of the first user, a biomarker of the first user, and a blood pressure of the user; and
identifying, based on the first user measurement, a bias of the first user.

8. The method of clause 1, wherein the first interface is one of an augmented reality device, a virtual reality device, a mixed reality device, and an immersive reality device configured to present the enhanced environment.

9. A system providing an immersive and response reality, the system comprising:
a processing device;
a memory communicatively coupled to the processing device and including computer readable instructions, that when executed by the processing device, cause the processing device to:
output, to a first interface in communication with a first user, an option for selecting an enhanced environment;
receive, from the first interface, a selection of the enhanced environment;
generate an enhanced environment based on the selection;
generate, in the enhanced environment, a model avatar;
generate, in the enhanced environment, a user avatar representative of a second user;
receive, from position sensors, second user position data representative of a location of the second user;
generate, from the second user position data, a position of the user avatar in the enhanced environment;
generate, in the enhanced environment, an instrument avatar representative of an instrument selected by and associated with the second user;
receive, from position sensors, instrument position data representative of a location of the instrument;
generate, from the instrument data, a position of the instrument avatar in the enhanced environment;
output, to a second interface in communication with the second user, the enhanced environment and a position of the second user, instrument and model avatars in the enhanced environment;
output, to the first interface, the enhanced environment and a position of the second user, the instrument and model avatars in the enhanced environment;
output, to the first interface, an option for selecting an action of the model avatar in the enhanced environment; and
receive, from the first interface, a selection of a first action of the model avatar in the enhanced environment;
generate, in the enhanced environment, an action of the model avatar based on the selection of the first action; and
output, to the first and second interfaces, the first action of the model avatar in the enhanced environment.

10. The system of clause 9, wherein the processing device is further configured to:
receive, from the position sensors, dynamic second user and instrument position data representative of a dynamic movement of at least one of the second user and instrument; and
generate, in the enhanced environment, movement of the second user and the instrument avatars based on dynamic movement of the second user and the instrument.

11. The system of clause 10, wherein the processing device is further configured to:
output, with the first interface, an option for selecting a second action of the model avatar; and
receive, from the first interface, a selection of a second action of the model avatar in the enhanced environment.

12. The system of clause 10, wherein the processing device is further configured to selectively modify, based on at least one of the position data and dynamic movement of at least one of the second user and the instrument, a second action of the model avatar.

13. The system of clause 9, wherein the processing device is further configured to:
receive, from an audio input device, an audible command of at least one of the first and second users; and
selectively modify, based at least in part on the audible command, a second action of the model avatar.

14. The system of clause 10, wherein the processing device is further configured to:
receive, from an audio input device, an audible command of at least one of the first and the second user; and
selectively modify, based on at least one of the dynamic movement and the audible command, a second action of the model avatar.

15. The system of clause 9, wherein the processing device is further configured to selectively identify a bias of at least one of the first and second user.

16. The system of clause 14, wherein the processing device is further configured to:
selectively identify a bias of the second user based at least in part on one of the dynamic movement and the audible command; and
selectively modify, based on the identified bias, the second action.

17. The system of clause 11, wherein the processing device is further configured to:
selectively identify a bias of the first user based at least in part on one of the selected second action of the model avatar; and
selectively modify, based on the identified bias, the second action.

18. The system of clause 15, wherein the processing device is further configured to:
receive, from a sensor associated with the second user, a second user measurement and where the second user measurement is at least one of a vital sign of the user, a respiration rate of the user, a heart rate of the user, a temperature of the user, an eye dilation, a metabolic marker, a biomarker, and a blood pressure of the user; and
identify, based on the second user measurement, a bias of the second user.

19. The system of clause 9, wherein the at least one of the first and second interfaces are one of an augmented reality device, a virtual reality device, a mixed reality device, and an immersive reality device configured to present the enhanced environment.

20. A system providing an immersive and response reality, the system comprising:
a processing device;
a memory communicatively coupled to the processing device and including computer-readable instructions, that when executed by the processing device, cause the processing device to:
output, to a first interface in communication with a first user, an option for selecting an enhanced environment;
receive, from the first interface, a selection of the enhanced environment;
generate an enhanced environment based on the selection;
generate, in the enhanced environment, a model avatar;
generate, in the enhanced environment, a first user avatar representative of the first user;
receive, from position sensors, first user position data representative of a location of the first user;
generate, from the first user position data, a position of the first user avatar in the enhanced environment;
generate, in the enhanced environment, an instrument avatar representative of an instrument selected by and associated with the first user;
receive, from position sensors, instrument position data representative of a location of the instrument;
generate, from the instrument data, a position of the instrument avatar in the enhanced environment;
output, to the first interface, the enhanced environment and a position of the first user, instrument and model avatar in the enhanced environment;
generate, in the enhanced environment, an action of the model avatar; and
output, to the first interface, the action of the model avatar in the enhanced environment.

21. The system of clause 20, wherein the processing device is further configured to:
receive, from the position sensors, dynamic first user and instrument position data representative of a dynamic movement of at least one of the first user and instrument;
generate, in the enhanced environment, movement of the first user and instrument avatars based on dynamic movement of the first user and the instrument; and
output, in the first interface, the movement of the first user and the instrument avatars.

22. The system of clause 21, wherein the processing device is further configured to selectively modify, based on at least one of the position data and dynamic movement of at least one of the first user and the instrument, a second action of the model avatar.

23. The system of clause 21, wherein the processing device is further configured to:
receive, from an audio input device, an audible command of the first user; and
selectively modify, based at least in part on the audible command, a second action of the model avatar.

24. The system of clause 20, wherein the processing device is further configured to selectively identify a bias of the first user.

25. The system of clause 23, wherein the processing device is further configured to:
selectively identify a bias of the first user based at least in part on one of the enhanced environment, dynamic movement, and the audible command; and
selectively modify, based on the identified bias, a third action of the model avatar.

26. The system of clause 24, wherein the processing device is further configured to:
receive, from a sensor associated with the first user, a first user measurement and where the first user measurement is at least one of a vital sign, a respiration rate, a heart rate, a temperature, an eye dilation, a metabolic marker, a biomarker, and a blood pressure of the first user;
identify, based on the first user measurement, a bias of the first user.

27. The system of clause 20, wherein the first interface is one of an augmented reality device, a virtual reality device, a mixed reality device, and an immersive reality device configured to present the enhanced environment.

28. The system of clause 20, wherein the first and second interfaces includes at least one of a microphone and a speaker.

29. The system of clause 28, wherein the processing device is further configured to:
receive, from the at least one microphone, an audible signal; and
output, to at least one speaker, the audible single.

30. The system of clause 20, wherein the processing device is further configured to:
generate, in the enhanced environment, at least one second user avatar representative of at least one second user;
receive, from position sensors, second user position data representative of a location of the second user;
generate, from the second user position data, a position of the second user avatar in the enhanced environment;
generate, in the enhanced environment, at least one instrument avatar representative of at least one instrument selected by and associated with the second user;
receive, from position sensors, instrument position data representative of a location of the instrument;
generate, from the instrument data, a position of the instrument avatar in the enhanced environment; and
output, to the first and the second interfaces, the enhanced environment and a position of the first user, second user, instrument and model avatars in the enhanced environment.

31. The system of clause 20, wherein the processing instrument is one of a gun, Taser, blunt object, sharp object, baton, pepper spray and handcuffs.

32. The system of clause 31, wherein the instrument avatar reflects one of the gun, Taser, blunt object, sharp object, baton, pepper spray and handcuffs.

33. A system providing an immersive and response reality, the system comprising:
a processing device;
a memory communicatively coupled to the processing device and including computer readable instructions, that when executed by the processing device, cause the processing device to:
output, to a first interface in communication with a first user, an option for selecting an enhanced environment;
receive, from the first interface, a selection of the enhanced environment;
generate the enhanced environment based on the selection;
generate, in the enhanced environment, a model avatar;
generate, in the enhanced environment, a user avatar representative of a second user;
receive, from position sensors, second user position data representative of a location of the second user;
generate, from the second user position data, a position of the user avatar in the enhanced environment;
generate, in the enhanced environment, an instrument avatar representative of an instrument selected by and associated with the second user;
receive, from the position sensors, instrument position data representative of a location of the instrument;
generate, from the instrument data, a position of the instrument avatar in the enhanced environment;
output, to a second interface in communication with the second user, the enhanced environment and a position of the second user, instrument and model avatars in the enhanced environment;
output, to the first interface, the enhanced environment and a position of the second user, the instrument and model avatars in the enhanced environment;
receive, from the first interface, a selection of a first action of the model avatar in the enhanced environment; and
perform, based on the first action, a sequential animation comprising transitioning the model avatar from the position to a second position in the enhanced environment.

34. The system of clause 33, wherein the sequential animation comprises a plurality of movements performed by the model avatar to transition through a plurality of positions to arrive at the second position.

35. The system of clause 33, wherein the position comprises a vertical standing position of the model avatar on a surface in the enhanced environment and the second position comprises a horizontal prone position of the model avatar on the surface.

36. The system of claim 33, wherein the sequential animation comprises a speed attribute controlled by a selected travel distance for the model avatar to move from the position to the second position.

37. The system of claim 36, wherein the speed attribute is increased when the selected travel distance exceeds a threshold distance.

38. The system of claim 33, wherein the sequential animation comprises walking, running, strafing, backpedaling, standing up, sitting down, crawling, jumping, or some combination thereof, and the sequential animation is further based on a selected location in the enhanced environment.

39. The system of clause 33, wherein the processing device is further to:
receive a single input from an input peripheral, wherein the single input is associated with a desired emotion for the model avatar to exhibit;
based on the single input:
animate the model avatar to exhibit the desired emotion in the enhanced environment,
emit audio comprising one or more spoken words made by the model avatar, and
synchronize lips of the model avatar to the one or more spoken words.

40. The system of claim 33, wherein the processing device is further to:
generate, in the enhanced environment, a second model avatar;
output, to the second interface in communication with the second user, the enhanced environment and the position of the second user, instrument and model avatars and a third position of the second model avatar in the enhanced environment;
output, to the first interface, the enhanced environment and the third position of the second user, the instrument and model avatars and the third position of the second model avatar in the enhanced environment;
receive, from the first interface, a second selection of a second action of the second model avatar in the enhanced environment; and
perform, based on the second action, a second sequential animation from the third position of the model avatar to a fourth position of the second model avatar in the enhanced environment.

41. The system of clause 40, wherein the first action and second action are performed concurrently in real-time or near real-time.

42. The system of clause 33, wherein the processing device is further to:
receive a selection to calibrate the first interface;
generate a calibrated view of the enhanced environment that reflects a perimeter of a physical environment; and
transmit, to the second interface, the calibrated view to calibrate the second interface.

43. The system of clause 33, wherein the processing device is further to:
receive, from the position sensors, dynamic second user and instrument position data representative of a dynamic movement of at least one of the second user and instrument; and
generate, in the enhanced environment, movement of the second user and the instrument avatars based on dynamic movement of the second user and the instrument.

44. The system of clause 33, wherein the processing device is further to selectively modify, based on at least one of the position data and dynamic movement of at least one of the second user and the instrument, a second action of the model avatar.

45. The system of clause 33, wherein the processing device is further to:
receive, from an audio input device, an audible command of at least one of the first and second users; and
selectively modify, based on at least one of the dynamic movement and the audible command, a second action of the model avatar.

46. The system of clause 45, wherein the processing device is further to:
selectively identify a bias of the second user based at least in part on one of the dynamic movement and the audible command; and
selectively modify, based on the identified bias, the second action.

47. The system of clause 33, wherein the at least one of the first and second interfaces are one of an augmented reality device, a virtual reality device, a mixed reality device, and an immersive reality device configured to present the enhanced environment.

48. The system of clause 33, wherein the processing device is further to:
receive, from a sensor associated with the second user, a second user measurement and where the second user measurement is at least one of a vital sign of the user, a respiration rate of the user, a heart rate of the user, a temperature of the user, an eye dilation, a metabolic marker, a biomarker, and a blood pressure of the user; and
identify, based on the second user measurement, a bias of the second user.

49. The system of clause 33, wherein the processing device is further to:
receive an input associated with a graphical element in the enhanced environment; and
responsive to receiving the input, display, at the graphical element in the second interface, a menu of actions associated with the graphical element.

50. The system of clause 33, wherein the processing device is further to:
receive, during a configuration mode, a selection of a location of a graphical element to include in the enhanced environment and an action associated with the graphical element; and
insert the graphical element at the location in the enhanced environment and associate the action with the graphical element.

What is claimed is:

1. A system providing an immersive and response reality, the system comprising:
a processing device;
a memory communicatively coupled to the processing device and including computer readable instructions, that when executed by the processing device, cause the processing device to:
output, to a first interface in communication with a first user, an option for selecting an enhanced environment;
receive, from the first interface, a selection of the enhanced environment;
generate the enhanced environment based on the selection;
generate, in the enhanced environment, a model avatar;
generate, in the enhanced environment, a user avatar representative of a second user;
receive, from position sensors, second user position data representative of a location of the second user;
generate, from the second user position data, a position of the user avatar in the enhanced environment;
generate, in the enhanced environment, an instrument avatar representative of an instrument selected by and associated with the second user;
receive, from the position sensors, instrument position data representative of a location of the instrument;
generate, from the instrument data, a position of the instrument avatar in the enhanced environment;
output, to a second interface in communication with the second user, the enhanced environment and a position of the second user, instrument and model avatars in the enhanced environment;
output, to the first interface, the enhanced environment and a position of the second user, the instrument and model avatars in the enhanced environment;
receive, from the first interface, a selection of a first action of the model avatar in the enhanced environment; and
perform, based on the first action, a sequential animation comprising transitioning the model avatar from the position to a second position in the enhanced environment.

2. The system of claim 1, wherein the sequential animation comprises a plurality of movements performed by the model avatar to transition through a plurality of positions to arrive at the second position.

3. The system of claim 1, wherein the position comprises a vertical standing position of the model avatar on a surface in the enhanced environment and the second position comprises a horizontal prone position of the model avatar on the surface.

4. The system of claim 1, wherein the sequential animation comprises a speed attribute controlled by a selected travel distance for the model avatar to move from the position to the second position.

5. The system of claim 4, wherein the speed attribute is increased when the selected travel distance exceeds a threshold distance.

6. The system of claim 1, wherein the sequential animation comprises walking, running, strafing, backpedaling, standing up, sitting down, crawling, jumping, or some combination thereof, and the sequential animation is further based on a selected location in the enhanced environment.

7. The system of claim 1, wherein the processing device is further to:
receive a single input from an input peripheral, wherein the single input is associated with a desired emotion for the model avatar to exhibit;
based on the single input:
animate the model avatar to exhibit the desired emotion in the enhanced environment,
emit audio comprising one or more spoken words made by the model avatar, and
synchronize lips of the model avatar to the one or more spoken words.

8. The system of claim 1, wherein the processing device is further to:
generate, in the enhanced environment, a second model avatar;
output, to the second interface in communication with the second user, the enhanced environment and the position of the second user, instrument and model avatars and a third position of the second model avatar in the enhanced environment;
output, to the first interface, the enhanced environment and the third position of the second user, the instrument and model avatars and the third position of the second model avatar in the enhanced environment;
receive, from the first interface, a second selection of a second action of the second model avatar in the enhanced environment; and
perform, based on the second action, a second sequential animation from the third position of the model avatar to a fourth position of the second model avatar in the enhanced environment.

9. The system of claim 8, wherein the first action and second action are performed concurrently in real-time or near real-time.

10. The system of claim 1, wherein the processing device is further to:
receive a selection to calibrate the first interface;
generate a calibrated view of the enhanced environment that reflects a perimeter of a physical environment; and
transmit, to the second interface, the calibrated view to calibrate the second interface.

11. The system of claim 1, wherein the processing device is further to:
receive, from the position sensors, dynamic second user and instrument position data representative of a dynamic movement of at least one of the second user and instrument; and
generate, in the enhanced environment, movement of the second user and the instrument avatars based on dynamic movement of the second user and the instrument.

12. The system of claim 1, wherein the processing device is further to selectively modify, based on at least one of the position data and dynamic movement of at least one of the second user and the instrument, a second action of the model avatar.

13. The system of claim 1, wherein the processing device is further to:
receive, from an audio input device, an audible command of at least one of the first and second users; and
selectively modify, based on at least one of the dynamic movement and the audible command, a second action of the model avatar.

14. The system of claim 13, wherein the processing device is further to:
selectively identify a bias of the second user based at least in part on one of the dynamic movement and the audible command; and
selectively modify, based on the identified bias, the second action.

15. The system of claim 1, wherein the at least one of the first and second interfaces are one of an augmented reality device, a virtual reality device, a mixed reality device, and an immersive reality device configured to present the enhanced environment.

16. The system of claim 1, wherein the processing device is further to:
receive, from a sensor associated with the second user, a second user measurement and where the second user measurement is at least one of a vital sign of the user, a respiration rate of the user, a heart rate of the user, a temperature of the user, an eye dilation, a metabolic marker, a biomarker, and a blood pressure of the user; and
identify, based on the second user measurement, a bias of the second user.

17. The system of claim 1, wherein the processing device is further to:
receive an input associated with a graphical element in the enhanced environment; and
responsive to receiving the input, display, at the graphical element in the second interface, a menu of actions associated with the graphical element.

18. The system of claim 1, wherein the processing device is further to:
receive, during a configuration mode, a selection of a location of a graphical element to include in the enhanced environment and an action associated with the graphical element; and
insert the graphical element at the location in the enhanced environment and associate the action with the graphical element.

19. A method for providing an immersive and response reality, the method comprising:
outputting, to a first interface in communication with a first user, an option for selecting an enhanced environment;
receiving, from the first interface, a selection of the enhanced environment;
generating the enhanced environment based on the selection;
generating, in the enhanced environment, a model avatar;
generating, in the enhanced environment, a user avatar representative of a second user;
receiving, from position sensors, second user position data representative of a location of the second user;
generating, from the second user position data, a position of the user avatar in the enhanced environment;
generating, in the enhanced environment, an instrument avatar representative of an instrument selected by and associated with the second user;
receiving, from position sensors, instrument position data representative of a location of the instrument;
generating, from the instrument data, a position of the instrument avatar in the enhanced environment;
outputting, to a second interface in communication with the second user, the enhanced environment and a position of the second user, instrument and model avatars in the enhanced environment;
outputting, to the first interface, the enhanced environment and a position of the second user, the instrument and model avatars in the enhanced environment;
receiving, from the first interface, a selection of a first action of the model avatar in the enhanced environment; and
performing, based on the first action, a sequential animation from the position of the model avatar to a second position of the model avatar in the enhanced environment.

20. A tangible, non-transitory computer-readable medium storing instructions that, when executed, cause the processing device to:
output, to a first interface in communication with a first user, an option for selecting an enhanced environment;
receive, from the first interface, a selection of the enhanced environment;
generate the enhanced environment based on the selection;
generate, in the enhanced environment, a model avatar;
generate, in the enhanced environment, a user avatar representative of a second user;
receive, from position sensors, second user position data representative of a location of the second user;
generate, from the second user position data, a position of the user avatar in the enhanced environment;
generate, in the enhanced environment, an instrument avatar representative of an instrument selected by and associated with the second user;
receive, from position sensors, instrument position data representative of a location of the instrument;
generate, from the instrument data, a position of the instrument avatar in the enhanced environment;
output, to a second interface in communication with the second user, the enhanced environment and a position of the second user, instrument and model avatars in the enhanced environment;
output, to the first interface, the enhanced environment and a position of the second user, the instrument and model avatars in the enhanced environment;
receive, from the first interface, a selection of a first action of the model avatar in the enhanced environment; and
perform, based on the first action, a sequential animation from the position of the model avatar to a second position of the model avatar in the enhanced environment.
